(19) United States
(12) Patent Application Publication
(10) Pub. No.: US 2025/0297959 A1
(43) Pub. Date: Sep. 25, 2025

(54) IMAGING DEVICE, OPERATION METHOD OF IMAGING DEVICE, AND PROGRAM

(71) Applicant: SONY GROUP CORPORATION, TOKYO (JP)

(72) Inventor: TETSU OGAWA, TOKYO (JP)

(21) Appl. No.: 18/869,042

(22) PCT Filed: May 17, 2023
(86) PCT No.: PCT/JP2023/018380

§ 371 Date: Nov. 25, 2024

(30) Foreign Application Priority Data
Jun. 3, 2022 (JP) 2022-090701

(51) Int. Cl. G01N 21/64; G01N 21/3563; G01N 21/359; G01N 21/55; G01N 21/63; G01N 21/84

(52) U.S. Cl. CPC G01N 21/6486; G01N 21/3563; G01N 21/359; G01N 21/55; G01N 21/84; G01N 2021/635; G01N 2021/6423; G01N 2021/8466

(57) ABSTRACT

The present disclosure relates to an imaging device, an operation method of an imaging device, and a program for enabling visualization and presentation of an invisible imaging target.

Incident light coming from a measurement target is separated. Spectral Raw data is generated on the basis of a spectral result. Spectral reflectance of the measurement target is calculated on the basis of the spectral Raw data. A visualized image is formed on the basis of the spectral reflectance. The visualized image is displayed in real time. The present disclosure is applicable to a spectroscopic camera.

### TECHNICAL FIELD

The present disclosure relates to an imaging device, an operation method of an imaging device, and a program, and particularly to an imaging device, an operation method of an imaging device, and a program capable of visualizing and presenting an invisible imaging target.

### BACKGROUND ART

In general, there has been increasingly spreading in agriculture fields in recent years such a technology which visualizes an invisible target by applying image sensing using spectroscopic measurement to allow observation or checking of the target.

For example, there has been performed such farm field checking which adopts NDVIs (Normalized Difference Vegetation Indexes) or normalized vegetation indexes using near infrared wavelength light or red wavelength light.

Moreover, recent development of plant physiology has been realizing observation of internal physical states of plants themselves. Accordingly, a measurement method which uses images of physical states of plants, particularly, images of photosynthesis and environmental stress responses, has been proposed (see PTL 1).

### CITATION LIST

### Patent Literature

[PTL 1]
PCT Patent Publication No. WO2020/013102

### SUMMARY

### Technical Problem

Meanwhile, concerning measurement of physical states of plants described in PTL 1, particularly, measurement of photosynthesis and environmental stress responses, there already exists such a mechanism which captures images necessary for measurement and then processes the captured images offline to carry out measurement of the physical states of the plants, particularly, the photosynthesis and the environmental stress responses.

However, information associated with the photosynthesis, the environmental stress responses, and the like is invisible information unless offline processing is completed.

Hence, for a user desiring to capture an image of an imaging target in a desired state, identification of an imaging direction and focusing on the imaging target are difficult to achieve. Accordingly, an image of the imaging target in the desired state cannot selectively be captured in an appropriate state.

The present disclosure has been developed in consideration of the above-mentioned circumstances, and particularly enables visualization and presentation of an invisible imaging target.

### Solution to Problem

An imaging device and a program according to one aspect of the present disclosure are directed to an imaging device and a program including a spectral unit that separates incident light coming from a measurement target, a spectral front end that generates a plurality of spectral Raw data on the basis of a spectral result obtained by the spectral unit, a spectral reflectance calculation section that calculates spectral reflectance of the measurement target on the basis of the spectral Raw data, a visualized image forming section that forms a visualized image on the basis of a specific value of the spectral reflectance, and a display section that displays the visualized image in real time.

An operation method of an imaging device according to one aspect of the present disclosure is directed to an operation method of an imaging device, the operation method including steps of separating incident light coming from a measurement target, generating spectral Raw data on the basis of a spectral result of the incident light, calculating spectral reflectance of the measurement target on the basis of the spectral Raw data, forming a visualized image on the basis of a specific value of the spectral reflectance, and displaying the visualized image in real time.

According to one aspect of the present disclosure, incident light coming from a measurement target is separated. Spectral Raw data is generated on the basis of a spectral result. Spectral reflectance of the measurement target is calculated on the basis of the spectral Raw data. A visualized image is formed on the basis of a specific value of the spectral reflectance. The visualized image is displayed in real time.

### BRIEF DESCRIPTION OF DRAWINGS

FIG. 1 is a diagram explaining incident light and diffused light.

FIG. 2 is a diagram explaining incident light, specular reflection light, diffused light, absorbed light, and transmitted light.

FIG. 3 is a diagram explaining irradiance, radiant emittance, radiance, radiant intensity, and radiant flux.

FIG. 4 is a diagram explaining spectral irradiance, spectral radiant emittance, spectral radiance, spectral radiant intensity, and spectral radiant flux.

FIG. 5 is a diagram explaining a spectral reflectance measurement method.

FIG. 6 is a diagram explaining a spectral irradiance measurement method.

FIG. 7 is an external appearance configuration diagram of an imaging device of the present disclosure.

FIG. 8 is a functional block diagram explaining functions achieved by the imaging device of the present disclosure.

FIG. 9 is a functional block diagram explaining functions achieved by a functional measuring section in FIG. 8.

FIG. 10 is a diagram explaining a 3D data cube.

FIG. 11 is a diagram explaining a spectral measurement example using a multi-lens.

FIG. 12 is a diagram explaining a display example of an RGB image.

FIG. 13 is a diagram explaining a PRI color map image.

FIG. 14 is a diagram explaining an example of a setting image for setting a maximum value and a minimum value of a color map image.

FIG. 15 is a diagram explaining a leaf surface light intensity PAR color map image.

FIG. 16 is a diagram explaining an NDVI color map image.

FIG. 17 is a diagram explaining an RGB image masked in a region where NDVIs are equal to or lower than a predetermined value.

FIG. 18 is a diagram explaining an RGB image masked in a region where predetermined vegetation indexes, photosynthesis speeds, and environmental stress responses are equal to or lower than predetermined values.

FIG. 19 is a diagram explaining an example of a synthetic image formed by superimposing a PRI color map image on an RGB image and synthesizing these images.

FIG. 20 is a diagram explaining a PAR-PRI scatter plot and a regression analysis result.

FIG. 21 is a diagram explaining a PAR-PRI heat map and a regression analysis result.

FIG. 22 is a diagram explaining a PAR-PRI box-and-whisker graph.

FIG. 23 is a diagram explaining an example of display when an ROI is set on the synthetic image in FIG. 19 by a user.

FIG. 24 is a diagram explaining an example of highlights on a leaf surface light intensity PAR color map image.

FIG. 25 is a diagram explaining an example of comparison display of individuals identified by an individual identification section and arranged in left and right parts side by side.

FIG. 26 is a flowchart explaining an imaging and displaying process.

FIG. 27 is a flowchart explaining a light source spectrum calculation process.

FIG. 28 is a flowchart explaining a light source spectrum acquisition process.

FIG. 29 is a flowchart explaining a functional measuring process.

FIG. 30 illustrates a configuration example of a general-purpose computer.

### DESCRIPTION OF EMBODIMENT

A preferred embodiment of the present disclosure will hereinafter be described in detail with reference to the accompanying drawings.

Note that constituent elements having substantially identical functional configurations in the present description and the drawings will be given identical reference signs to avoid repetitive explanation.

A mode for carrying out the present technology will hereinafter be described. The description will be presented in the following order.
1. Outline of present disclosure
2. Preferred embodiment
3. Example executed by software

### 1. Outline of Present Disclosure

### <Diffuse Reflection Spectroscopy>

The present disclosure particularly enables visualization and presentation of an invisible imaging target.

Accordingly, first, diffuse reflection spectroscopy, which is a principle of invisible imaging target measurement, will be described, and associated term definitions will also be touched upon.

For example, the invisible imaging target is a vegetation index such as an NDVI (Normalized Difference Vegetation Index) and a PRI (Photochemical Reflectance Index), chlorophyll fluorescence generated from a plant, or the like.

Note that the NDVI is defined as (ρNIR−ρR)/(ρNIR+ρR). In this definition, ρNIR and ρR are values of spectral reflectance of NIR (near infrared light) and spectral reflectance of R (red light), respectively. Moreover, the PRI is defined as (ρ531−ρ570)/(ρ531+ρ570). In this definition, ρ531 and ρ570 are values of spectral emissivity at a wavelength of 531 nm and spectral reflectance at a wavelength of 570 nm, respectively. Further, chlorophyll fluorescence is a value calculated from spectral radiance at a specific wavelength.

These vegetation indexes corresponding to the invisible imaging target are calculated from spectral reflectance, and the principle of the respective measurements follows characteristics presented below.

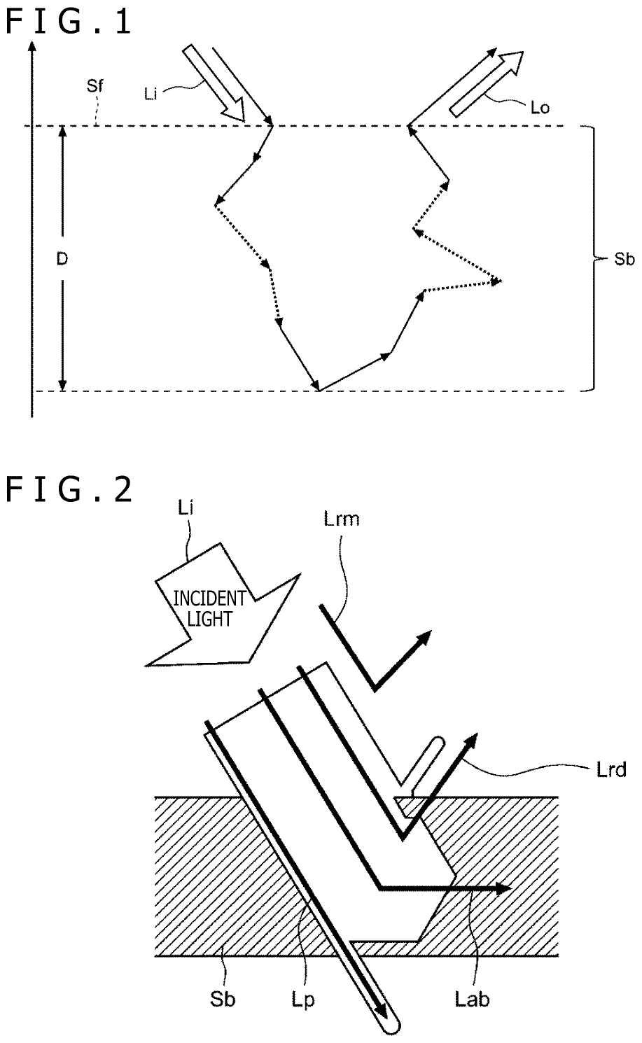

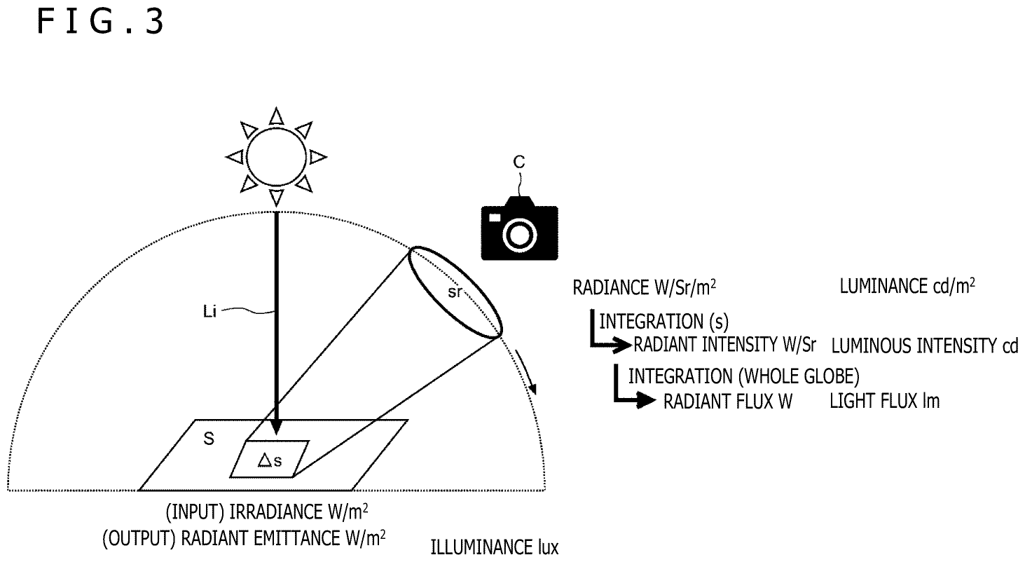

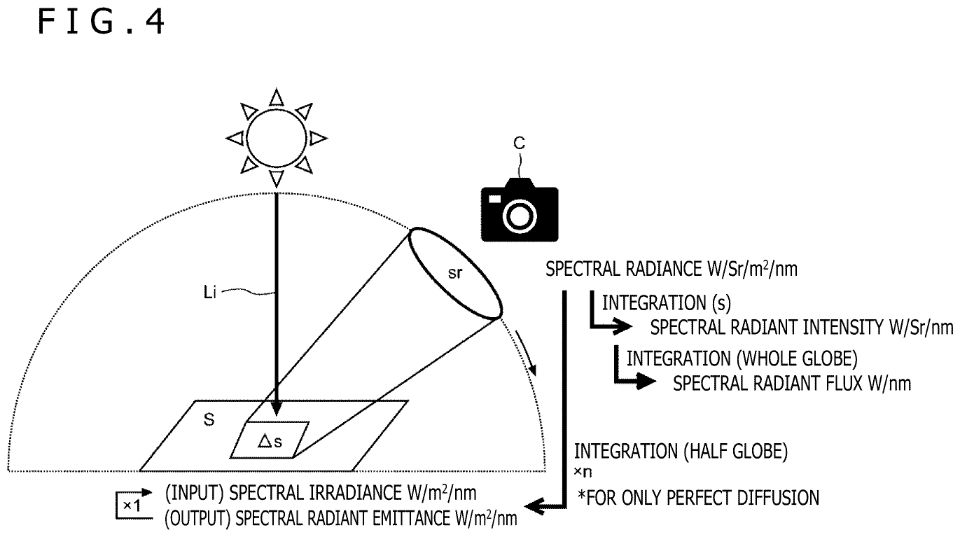

Specifically, as illustrated in FIG. 1, when incident light Li enters a sample surface Sf of a sample Sb constituting a leaf of a plant or the like, light having a specific wavelength is absorbed by a substance composition inside the sample Sb. Accordingly, at the time of re-release of the incident light Li from the sample surface Sf as diffused light Lo, the diffused light Lo has spectral characteristics different from those of the incident light Li.

Note that FIG. 1 illustrates a state where the incident light Li enters the sample surface Sf of the sample Sb having a thickness D, travels along an optical path indicated by a solid line and a dotted line, and is re-released as the diffused light Lo.

More specifically, as illustrated in FIG. 2, when the incident light Li enters the sample Sb constituting a leaf of a plant or the like, a part of the incident light Li reflects as total reflection light Lrm by specular reflection. A different part reflects as diffused light Lrd (=Lo), a further different part is absorbed as absorbed light Lab by the sample Sb, and a still further different part passes through the sample Sb as transmitted light Lp.

Note that, in a case where the incident light Li is red light, approximately 5% to 6% of the incident light Li becomes the diffused light Lrd (=Lo), approximately 84% of the incident light Li becomes the absorbed light Lab, approximately 5% to 6% of the incident light Li becomes the transmitted light Lp, and the rest of the incident light Li becomes the total reflection light Lrm.

Moreover, the absorbed light Lab is largely absorbed by pigments such as chlorophyll and carotenoids.

In this case, the diffused light Lo (=Lrd) is a part of components of the incident light Li from which the absorbed light Lab and the transmitted light Lp are excluded, and therefore has spectral characteristics different from those of the incident light Li.

The vegetation index or the like of the sample Sb which is an invisible measurement target and constitutes an internal substance composition of a plant is measured by diffuse reflection spectroscopy utilizing the above characteristics, on the basis of a change of the spectral characteristics of the diffused light Lo from those of the incident light Li.

### <Radiance, Radiant Emittance, Radiant Intensity, Radiant Intensity, and Radiant Flux>

For measuring the change of the spectral characteristics described above, radiance and radiant intensity are measured instead of light luminance and intensity measured by an ordinary imaging device.

The radiance herein refers to a physical quantity indicating radiant flux released in a predetermined direction from a dot-shaped radiation source.

Moreover, the radiant intensity refers to a physical quantity indicating radiant energy released in a unit time in a predetermined direction from a dot-shaped radiation source.

Irradiance (W/m²) is input of the incident light Li from the sun as a light source per a unit area Δs on an earth surface S on the earth, while radiant emittance (W/m²) is output corresponding to reflection from the earth surface S caused according to this irradiance. Note that (W/m²) is a unit of a radiation amount, and that illuminance (lux) is a corresponding light measurement amount.

The radiance is luminance observed in a case where an imaging device C captures an image of light reflected from the earth surface S with radiant emittance (W/m²).

The radiance (W/sr/m²) is expressed as radiant emittance (W/m²) per unit solid angle (sr: steradian).

In other words, the radiance (W/sr/m²) is calculated by differentiating the radiant intensity (W/sr) by an area, while the radiant intensity (W/sr) is calculated by differentiating radiant flux (W) by a solid angle (sr).

Accordingly, the radiant intensity (W/sr) is calculated by integrating the radiance (W/sr/m²) by an area, while the radiant flux (W) is calculated by integrating the radiant intensity (W/sr) by the solid angle. Note that each of the radiance (W/sr/m²), the radiant intensity (W/sr), and the radiant flux (W) is a unit of a radiation amount, and that corresponding light measurement amounts are expressed as luminance (cd/m²), luminous intensity (cd), and light flux (lm), respectively.

### <Spectral Radiance, Spectral Radiant Emittance, Spectral Radiant Intensity, Spectral Radiant Intensity, and Spectral Radiant Flux>

As described above, a vegetation index corresponding to an invisible observation target is obtained by observation of spectral characteristics. Accordingly, the radiance and the radiant intensity described above are expressed as spectral radiance and spectral radiant intensity, respectively, at a specific wavelength, and expressed as radiance and radiant intensity per unit wavelength.

Specifically, each of spectral irradiance and spectral radiant emittance is obtained in units of (W/m²/nm).

Accordingly, the unit of spectral radiance is (W/sr/m²/nm), the unit of spectral radiant intensity is (W/sr/nm), and the unit of spectral radiant flux is (W/nm).

Moreover, in a case where a sample is considered to achieve perfect diffuse reflection at spectral radiance observed by the imaging device C, spectral radiant emittance is calculated by multiplying a measurement value by n.

Further, in a case where the sample Sb has reflectance of 100%, spectral radiant emittance and spectral illuminance have the same value.

### <Measurement of Spectral Reflectance>

Spectral characteristics of the diffused light Lo described with reference to FIG. 1 include spectral reflectance and spectral radiance of the diffused light Lo with respect to the sample Sb. Either or both of these are required according to a vegetation index type or the like desired to be measured.

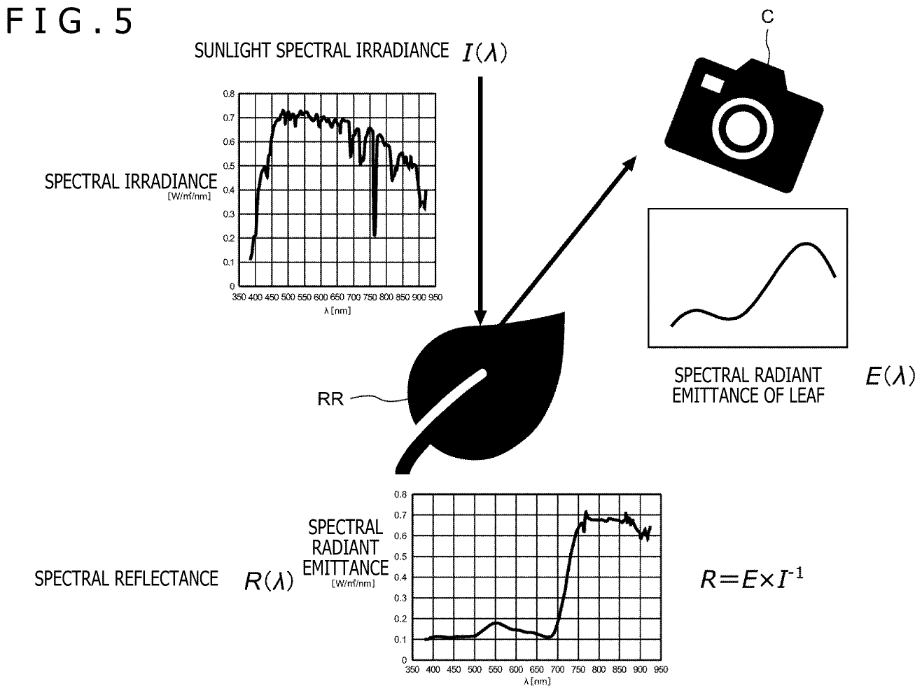

As illustrated in FIG. 5, spectral reflectance R(λ) which is reflectance of a spectral component included in the incident light Li and corresponding to a wavelength λ in a leaf RR constituted by the sample Sb is a value (=E(λ)/I(λ)=E×I⁻¹) calculated by dividing spectral radiant emittance E(λ), which indicates the diffused light Lo as the incident light Li reflected on the leaf RR and observed by the imaging device C, by sunlight spectral irradiance I(λ) of the incident light Li.

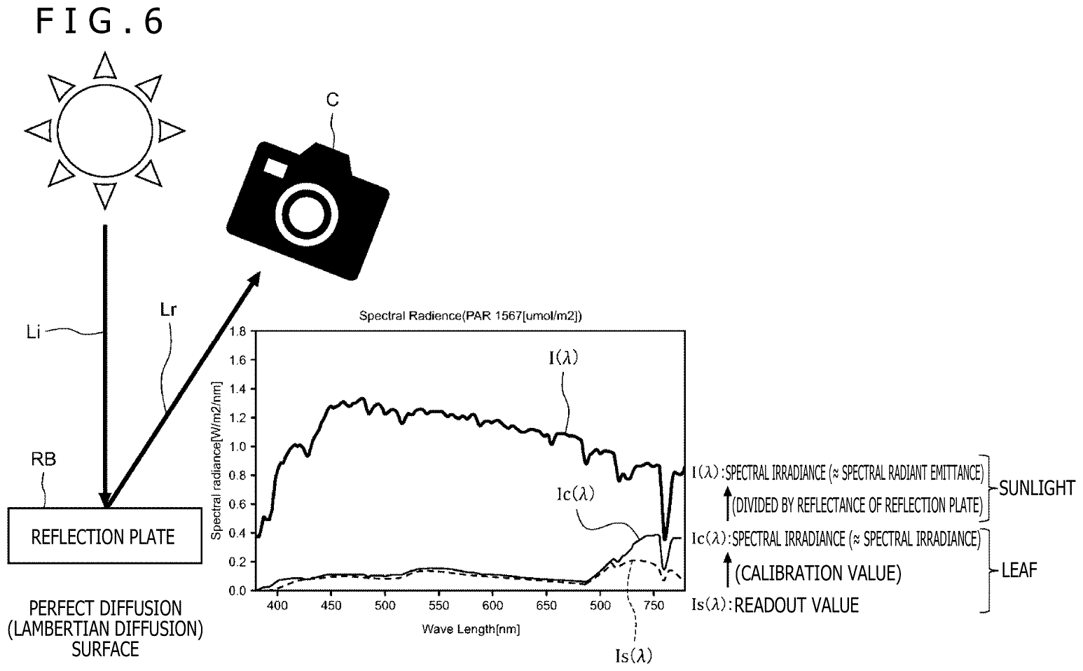

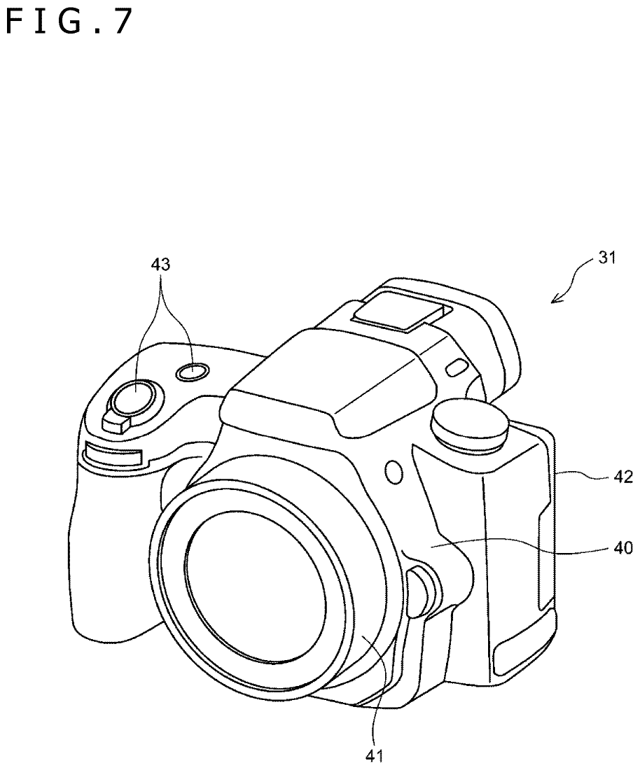

As illustrated in FIG. 6, the sunlight spectral irradiance I(λ) in this case is obtained from an observation value obtained at the time of observation of reflection light Lr, which is produced by reflection of the incident light Li on a standard diffuse reflection plate RB constituted by a perfect diffusion plate (Lambertian diffusion plate), with use of the imaging device C.

Here, spectral radiance Ic(λ) is obtained by calibrating a readout value Is(λ) read from an image sensor of the imaging device C. In addition, the sunlight spectral irradiance I(λ) is obtained by dividing spectral radiance Ic(λ) by reflectance of the standard diffuse reflection plate RB.

Note that, in a case where only spectral reflectance is required, spectral radiance may not be calculated if a ratio of input light to output light is acquirable. Moreover, calibration also need not be carried out. Accordingly, the process for obtaining spectral radiance and calibration can be eliminated.

However, for measuring fluorescence (chlorophyll fluorescence) and leaf surface light intensity, absolute values are required. Accordingly, measurement of spectral radiance reflecting calibration is necessary.

Meanwhile, since measurement of vegetation indexes or the like obtained from spectral radiance, spectral reflectance, and others with use of the diffuse reflection spectroscopy described above requires an offline process applied to captured images, information obtained at the time of imaging with use of an imaging device is invisible information not visualized. Accordingly, for example, an image of an imaging target in a predetermined state based on a vegetation index cannot selectively be captured in an appropriate state.

In other words, since information for identifying the imaging target is invisible information, the desired imaging target cannot visually be identified. Hence, an image of the desired imaging target cannot be captured with appropriate exposure and in an appropriate focused state.

According to the present disclosure, therefore, information indicating a state of vegetation, which has been invisible information such as vegetation indexes, is allowed to be visualized in real time and presented as live-view display at the time of observation of vegetation with use of an imaging device, and an image of an imaging target in a specific state can be selectively captured in an appropriate state.

### 2. Preferred Embodiment

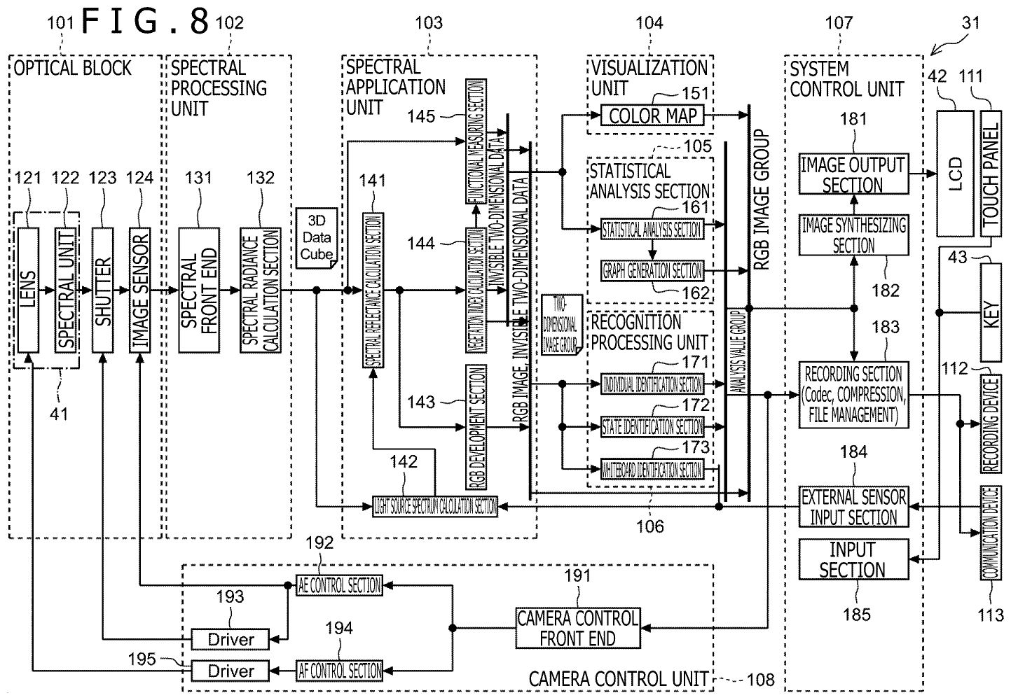

Described next with reference to FIGS. 7 and 8 will be an imaging device of the preferred embodiment to which the technology of the present disclosure is applied. Note that FIG. 7 is a perspective diagram of an external appearance of an imaging device 31 of the present disclosure, while FIG. 8 is a functional block diagram explaining functions achieved by the imaging device 31.

As illustrated in FIG. 7, the imaging device 31 has a typical interchangeable lens type camera shape, and includes a main body 40, a lens unit 41, an LCD (Liquid Crystal Display) 42, and a key 43.

The lens unit 41 has a configuration including a lens 121 (FIG. 8) and a spectral unit 122 (FIG. 8) both built in the lens unit 41, and separates incident light for each predetermined band, and collects and focuses light on an imaging surface of an image sensor (imaging element) 124 (FIG. 8) provided inside the main body 40.

The LCD 42 is provided on the back side of the imaging device 31 with respect to an incident direction of incident light, displays various types of information, and has a touch panel 111 (FIG. 8) as well to receive various types of operation input. Moreover, the LCD 42 converts invisible information, which is invisible unless image processing is applied thereto, such as vegetation indexes, associated with a subject within a visual field of the lens unit 41, into visualized information such as color map images, and presents the visualized information in real time by what is generally called live view display.

The key 43 has a function as a shutter button operated for capturing still images, and also functions as a button operated for issuing instructions of a recording start and a recording end during capturing of moving images.

As illustrated in FIG. 8, the imaging device 31 includes an optical block 101, a spectral processing unit 102, a spectral application unit 103, a visualization unit 104, a statistical analysis unit 105, a recognition processing unit 106, a system control unit 107, a camera control unit 108, the touch panel 111, a recording device 112, a communication device 113, the LCD 42, and the key 43.

The optical block 101 includes the lens unit 41, and generates a spectral imaging result including a pixel signal according to an amount of incident light separated and focused by the lens unit 41, and outputs the spectral imaging result to the spectral processing unit 102.

More specifically, the optical block 101 includes the lens 121, the spectral unit 122, a shutter 123, and the image sensor 124, the lens 121 and the spectral unit 122 constituting the lens unit 41.

The lens 121 configured to be driven in an incident direction of incident light by a Driver 195 controlled by an AF control section 194 of the camera control unit 108 transmits incident light, and also focuses the incident light on an imaging surface of the image sensor 124.

The spectral unit 122 is an optical unit which separates incident light. The spectral unit 122 separates incident light for each predetermined wavelength band, and introduces the separated light into the image sensor 124 via the shutter 123. For example, the spectral unit 122 is of a spectral type using diffraction gratings (CTIS (Computed Tomography Imaging Spectrometer) type) or a multi-lens band-pass filter type. The spectral unit 122 is not required to be a unit of these types and may have any configuration as long as light separation is achievable, such as a surface plasmon resonance type, a Fourier spectral type, and a Fabry-Perot type, for example.

In a case where the spectral unit 122 is of the CTIS type using diffraction gratings, information including a spectral direction and a resolution direction is input to the image sensor 124.

In a case where the spectral unit 122 is of the multi-lens band-pass filter type, a plurality of spectral images transmitted through the lens 121, which includes a plurality of lenses provided for each of at least four types or more of wavelength bands including visible light (RGB (red light, green light, blue light)) and NIR (near infrared light), are formed on the image sensor 124.

The shutter 123 is provided in a preceding stage of the image sensor 124, and configured such that opening or closing is mechanically controlled by a Driver 193 controlled by an AE control section 192 of the camera control unit 108. In this manner, a light amount is controlled according to control of transmission or blocking of incident light entering via the lens unit 41.

The image sensor 124 includes CMOS (Complementary Metal Oxide Semiconductor) image sensors, CCD (Charge Coupled Device) image sensors, or the like arranged in an array for each pixel, and outputs a pixel signal corresponding to an amount of incident light focused and separated by the lens unit 41, in an opened state of the shutter 123.

The spectral processing unit 102 generates a 3D data cube described below, on the basis of a spectral imaging result, and outputs the generated 3D data cube to the spectral application unit 103.

More specifically, the spectral processing unit 102 includes a spectral front end 131 and a spectral radiance calculation section 132.

The spectral front end 131 divides data into a plurality of wavelength images (spectral images), i.e., divides Raw data as readout values obtained by the image sensor 124 into data for each wavelength, and outputs the divided Raw data to the spectral radiance calculation section 132 as spectral Raw data.

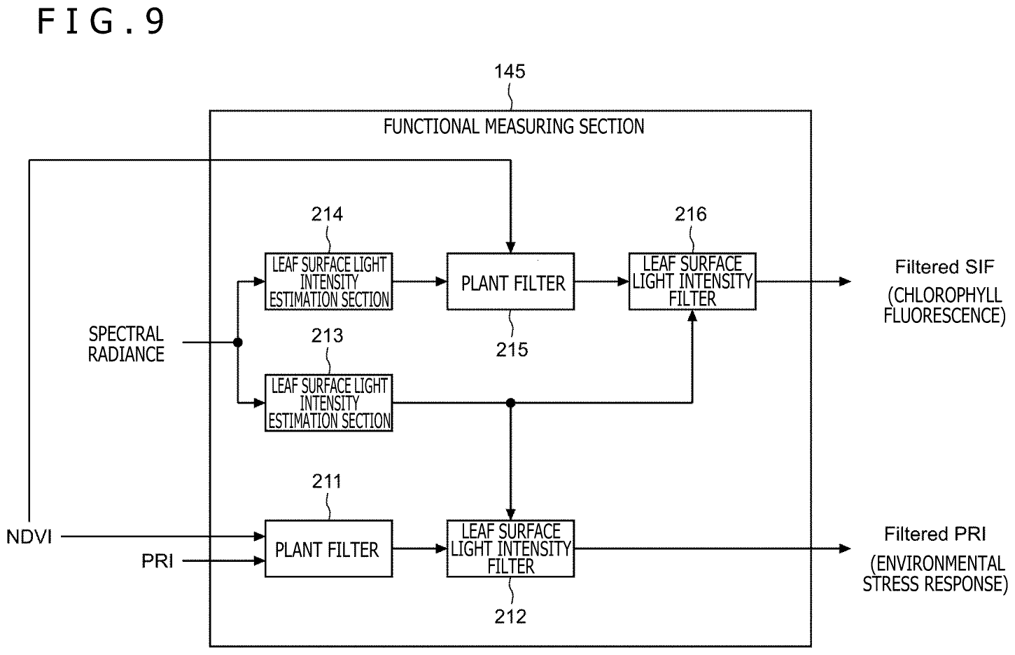

In a case where the spectral unit 122 is of the CTIS type, information including a spectral direction and a resolution direction read by the image sensor 124 is divided into a plurality of two-dimensional data for each wavelength, and converted into 3D data cube, for example. Note that details of the 3D data cube will be described with reference to FIG. 9.

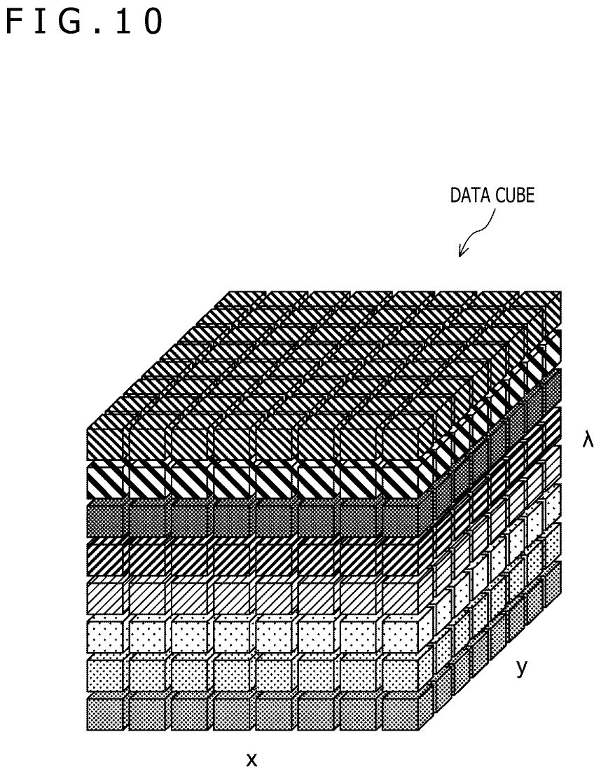

Moreover, in a case where the spectral unit 122 is of the multi-lens band-pass filter type, images are cut out for each wavelength and then aligned with each other. Thereafter, information in a form substantially similar to the 3D data cube is output. Note that details of an example of the multi-lens band-pass filter will be described below with reference to FIG. 10.

The spectral radiance calculation section 132 calculates spectral radiance of a measurement target from the spectral Raw data, which includes the readout values obtained by the image sensor 124 and separated and supplied by the spectral front end 131, in consideration of spectral characteristics of the optical system such as the image sensor 124 and the lens 121.

More specifically, the spectral radiance calculation section 132 calculates the spectral radiance on the basis of calculation of the following equation (1), for example.

$$I = Si / F \qquad ( 1 )$$

In this equation, I represents spectral radiance, Si represents a readout value (spectral Raw data) obtained by the image sensor 124 and separated, and F represents the spectral characteristic of the optical system.

The spectral application unit 103 forms an RGB image as a visible image and invisible two-dimensional data including invisible information on the basis of the spectral radiance supplied in the form of 3D data cube, and outputs these to the visualization unit 104, the statistical analysis unit 105, and the recognition processing unit 106.

The spectral application unit 103 includes a spectral reflectance calculation section 141, a light source spectrum calculation section 142, an RGB development section 143, a vegetation index calculation section 144, and a functional measuring section 145.

The spectral reflectance calculation section 141 calculates spectral reflectance by using the following equation (2) on the basis of spectral radiance of a measurement target supplied from the spectral processing unit 102 and spectral radiance associated with a light source and supplied from the light source spectrum calculation section 142, and outputs the calculated spectral reflectance to the vegetation index calculation section 144.

$$R = I / L \qquad ( 2 )$$

In this equation, R represents spectral reflectance, I represents spectral radiance of the measurement target, and L represents spectral radiance of the light source.

Note that the spectral reflectance calculation section 141 may calculate the spectral reflectance on the basis of the spectral Raw data in addition to the spectral radiance associated with the measurement target and supplied from the spectral processing unit 102 and the spectral radiance associated with the light source and supplied from the light source spectrum calculation section 142, and output the calculated spectral reflectance to the vegetation index calculation section 144. At this time, in a case where the spectral radiance is unnecessary (in a case where the functional measuring section 145 is not used), the spectral radiance calculation section 132 is not required to perform conversion into spectral radiance. Specifically, in this case, the spectral reflectance calculation section 141 and the light source spectrum calculation section 142 operate according to input which is the readout value (spectral Raw data) obtained by the image sensor 124 and separated. Moreover, the spectral reflectance calculation section 141 outputs the calculated spectral reflectance in the form of the 3D data cube described above.

The light source spectrum calculation section 142 calculates the spectral radiance of the light source on the basis of a readout value obtained by the image sensor 124 and associated with a region identified according to designation of the position of the standard diffuse reflection plate in an image by the user or according to identification of the position of the standard diffuse reflection plate by image recognition or the like from an image, and outputs the calculated spectral radiance to the spectral reflectance calculation section 141.

Moreover, in a case where the position of the standard diffuse reflection plate described above is not designated, identified, or detectable, the light source spectrum calculation section 142 may acquire, via communication, information detected by a sensor detecting spectral radiance of an external light source.

Further, the light source spectrum calculation section 142 may store last detected spectral radiance of the light source, and use the last detected spectral radiance in a case where the standard diffuse reflection plate described above is not designated or detectable.

The RGB development section 143 forms an RGB image on the basis of the spectral reflection luminance supplied from the spectral processing unit 102, and the spectral reflectance calculated by the spectral reflectance calculation section 141, and outputs the formed RGB image to the recognition processing unit 106.

Note that the RGB image formed by the RGB development section 143 may be an image including pixel values based on spectral radiance of a typical measurement target. However, the RGB image herein is an image including pixel values based on spectral reflectance obtained by dividing the spectral radiance of the measurement target by the spectral radiance of the light source. In other words, the RGB image herein is an image including pixel values generated on the basis of values obtained by normalizing the spectral radiance of the measurement target on the basis of the spectral radiance of the light source.

Specifically, in a case where an image including pixel values based on spectral radiance of a typical measurement target is handled as an RGB image, for example, an image to be obtained in the daytime is a whitish image on the whole because sunlight as a light source is white light in the daytime. However, an image to be obtained in the evening is a reddish image on the whole because sunlight as the light source becomes red color in the evening. As a result, there is a possibility that an RGB image expected to have uniform colors have different colors according to a change of sunlight as the light source.

However, in a case where an RGB image includes pixel values based on spectral reflectance as an image formed by the RGB development section 143 of the present disclosure, the pixel values are calculated from values normalized on the basis of spectral radiance of sunlight as the light source. Accordingly, the influence of the change of sunlight as the light source is cancelled. As a result, an RGB image formed by the RGB development section 143 of the present disclosure can become an image having appropriate colors regardless of the change of sunlight as the light source.

The vegetation index calculation section 144 calculates vegetation indexes such as NDVIs and PRIs on the basis of the spectral reflectance, and outputs the calculated vegetation indexes to the functional measuring section 145, the visualization unit 104, the statistical analysis unit 105, and the recognition processing unit 106 as invisible two-dimensional data.

The functional measuring section 145 measures chlorophyll fluorescence and leaf surface light intensity on the basis of the spectral radiance associated with the measurement target and supplied from the spectral processing unit 102 and the various types of vegetation indexes supplied from the vegetation index calculation section 144, calculates photosynthesis speeds (Filtered SIF (Solar Induced Chlorophyll Fluorescence)) and environmental stress responses (Filtered PRIs) by applying processing using a specific algorithm, and outputs the calculated photosynthesis speeds and environmental stress responses to the visualization unit 104, the statistical analysis unit 105, and the recognition processing unit 106 as invisible two-dimensional data. Moreover, the functional measuring section 145 may obtain photosynthesis speeds (ETR (Electron Transport Rates): electron transmission speeds of photosystem II) and environmental stress responses (NPQpri (Non-photochemical quenching by PRIs: quantitative estimation values of environmental stress responses generated from PRIs)), as values more accurate than the Filtered SIF and the Filtered PRIs. Note that a detailed configuration of the functional measuring section 145 will be described below with reference to FIG. 9.

The visualization unit 104 including a color map 151 forms a color map image (visualized image) including an RGB image by applying color mapping in RGB or the like to two-dimensional invisible data including the various types of vegetation indexes, the chlorophyll fluorescence, the leaf surface light intensity, the photosynthesis speeds, and the environmental stress responses supplied from the vegetation index calculation section 144 and the functional measuring section 145 of the spectral application unit 103, and outputs the formed color map image to the system control unit 107.

The statistical analysis unit 105 statistically analyzes respective numerical values of the two-dimensional invisible data including the various types of vegetation indexes, the chlorophyll fluorescence, the leaf surface light intensity, the photosynthesis speeds, and the environmental stress responses supplied from the vegetation index calculation section 144 and the functional measuring section 145 of the spectral application unit 103, forms a graph image on the basis of an analysis result, and then outputs the analysis result and the graph image to the system control unit 107.

More specifically, the statistical analysis unit 105 includes a statistical analysis section 161 and a graph generation section 162.

The statistical analysis section 161 statistically analyzes the numerical values of the two-dimensional invisible data including the various types of vegetation indexes, the chlorophyll fluorescence, the leaf surface light intensity, the photosynthesis speeds, and the environmental stress responses supplied from the vegetation index calculation section 144 and the functional measuring section 145 of the spectral application unit 103, and outputs an analysis result to the graph generation section 162 and the system control unit 107 as analysis values. For example, the statistical analysis section 161 obtains a correlation between the leaf surface light intensity and the environmental stress responses on the basis of statistical analysis.

In a case where information for designating an ROI (Region of Interest) region is input from the touch panel 111 or the key 43 operated for inputting operation input corresponding to details of operation via the input section 185, the statistical analysis section 161 may extract only the ROI region to which statistical analysis is applied and perform statistical analysis for the extracted ROI region.

The graph generation section 162 creates a scatter plot, a heat map, a box-and-whisker graph, or the like as a graph image on the basis of the analysis result obtained by the statistical analysis section 161, and outputs the created graph image to the system control unit 107. Specifically, in a case where a correlation between the leaf surface light intensity and the environmental stress response is obtained from the statistical analysis performed by the statistical analysis section 161, for example, the graph generation section 162 generates a graph representing the obtained correlation.

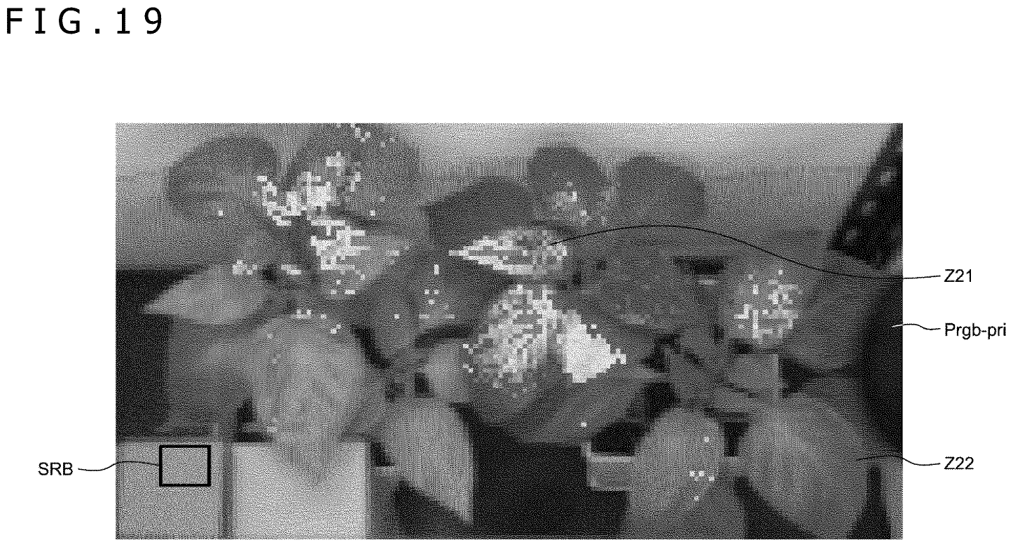

Note that each of the RGB image output from the RGB development section 143, the color map image output from the visualization unit 104, and the graph image supplied from the graph generation section 162 constitutes an RGB image group. This RGB image group is output to an image synthesizing section 182 and a recording section 183 of the system control unit 107. In addition, details of the statistical analysis and the generated graph will be described below with reference to FIGS. 19 to 21.

The recognition processing unit 106 performs an identification process such as individual identification, state identification, and whiteboard identification on the basis of the RGB image and the invisible two-dimensional data supplied from the spectral application unit 103, and outputs an identification result to the spectral application unit 103, the system control unit 107, and the camera control unit 108.

More specifically, the recognition processing unit 106 includes an individual identification section 171, a state identification section 172, and a whiteboard identification section 173.

The individual identification section 171 identifies a measurement target for each unit on the basis of the RGB image and the invisible two-dimensional data supplied from the spectral application unit 103. For example, the individual identification section 171 identifies individual plants one by one on the basis of the RGB image and the invisible two-dimensional data supplied from the spectral application unit 103.

Note that the individual identification section 171 may achieve identification not only on the basis of the RGB image and the invisible two-dimensional data supplied from the spectral application unit 103, but also on the basis of other information. For example, the individual identification section 171 may identify individuals by tagging (attaching identifiers) based on image recognition using the RGB image, tagging using two-dimensional barcodes, tagging for each position information with use of GIS (Geographic Information System) information, tagging input by operation of the touch panel 111, or by other methods.

The state identification section 172 identifies a state of the measurement target in a range of a measurement result (trait or environmental response) on the basis of the RGB image and the invisible two-dimensional data supplied from the spectral application unit 103.

Note that the trait is a term expressing a shape and a static characteristic. Accordingly, in a case where the term “trait” is adopted to indicate a shape, for example, a “trait of a leaf of a plant” includes a “shape of a leaf of a plant,” as an example. Meanwhile, in a case where the term “trait” is adopted to indicate a static characteristic, for example, a “trait of a leaf of a plant” includes a “chlorophyll concentration of a leaf of a plant,” as an example.

In addition, the environmental response is a term expressing a shape change and a response characteristic. Accordingly, in a case where the term “environmental response” is adopted to indicate a shape change, for example, an “environmental response of a plant” includes a “trait change of a leaf according to acclimation of a plant” and the like, as an example. Meanwhile, in a case where the term “environmental response” is adopted to indicate a response characteristic, for example, an “environmental response of a plant” includes a “change of a photosynthesis speed according to a change of light intensity of a plant,” as an example.

For example, the state identification section 172 identifies whether or not a plant is in a state exhibiting a certain degree or more of an environmental stress response, on the basis of the environmental stress response included in the RGB image and the invisible two-dimensional data supplied from the spectral application unit 103.

The whiteboard identification section 173 recognizes the position of the whiteboard (standard diffuse reflection plate) on the basis of the RGB image and the invisible two-dimensional data supplied from the spectral application unit 103, and outputs a recognition result to the light source spectrum calculation section 142 of the spectral application unit 103.

Note that each of the statistical analysis result obtained by the statistical analysis section 161, the individual identification result obtained by the individual identification section 171, and the state identification result obtained by the state identification section 172 constitutes an analysis value group. This analysis value group is output to the image synthesizing section 182 and the recording section 183 of the system control unit 107.

The system control unit 107 forms an image on the basis of information including the RGB image group and the analysis value group supplied from the spectral application unit 103, the visualization unit 104, the statistical analysis unit 105, and the recognition processing unit 106, and displays the formed image on the LCD 42 or outputs the formed image to the recording device 112 and the communication device 113.

Moreover, the system control unit 107 controls the camera control unit 108 on the basis of operation input which is input from the key 43 and the touch panel 111 operated by the user, or information indicating the analysis value group.

More specifically, the system control unit 107 includes an image output section 181, the image synthesizing section 182, the recording section (Codec, compression, file management) 183, an external sensor input section 184, and an input section 185.

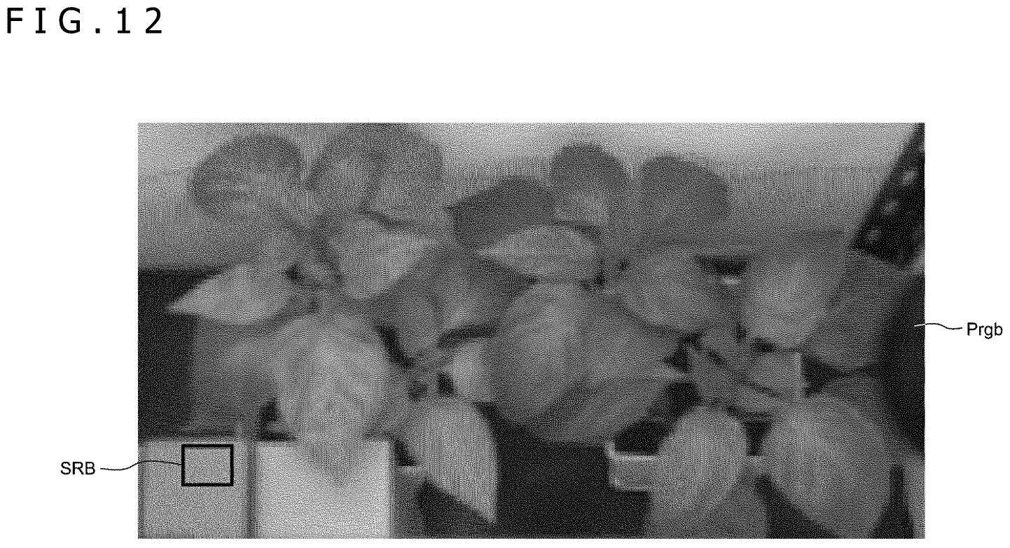

The image synthesizing section 182 synthesizes information indicating the RGB image group including the RGB image, the visualized image, and the graph image and information indicating the analysis value group such as the statistical analysis result and the results of individual identification and state identification into one-screen image, outputs the synthetic image to the image output section 181, and displays the synthetic image on the LCD 43. Note that details of a display example of the synthetic image formed by the image synthesizing section 182 will be described below with reference to FIGS. 12 to 25.

The recording section 183 encodes the RGB image group including the RGB image, the visualized image, and the graph image and the analysis value group such as the statistical analysis result and the results of individual identification and state identification, compresses the encoded groups, and causes the recording device 112 including an HDD, an SSD, or the like to record the compressed groups as file information and also transmits the file information to an unillustrated external device via the communication device 113.

At this time, the recording section 183 may divide the RGB image group and the analysis value group for each individual identification result or state identification result, and tag the RGB image group and the analysis value group with image-attached data (metadata, etc.) such as Exif (attach an identifier). Alternatively, the recording section 183 may switch folders for recording the RGB image group and the analysis value group in the recording device 112, or cause the communication device 113 to transmit the RGB image group and the analysis value group to an unillustrated different external device.

The external sensor input section 184 receives input of a measurement result from an unillustrated sensor provided outside, such as a sensor for measuring light source spectral radiance of sunlight or the like, for example, and outputs the input to the light source spectrum calculation section 142 and the whiteboard identification section 173.

In addition, the sensor for measuring the light source spectral radiance associated with sunlight or the like and supplied to the external sensor input section 184 may be attached to the imaging device 31 by an attachment, or may be of a such type which introduces sunlight above the imaging device 31 via a dichroic mirror or the like.

The input section 185 receives various types of operation input from the key 43 and the touch panel 111, and supplies information associated with the received operation input, to the spectral application unit 103 and the camera control unit 108.

More specifically, in a case of input of light source spectral radiance, the input section 185 supplies information indicating the light source spectral radiance as the received input, to the light source spectrum calculation section 142 and a camera control front end 191, while not depicted in the figure with detailed arrows or the like.

The camera control unit 108 controls actions of the lens 121, the shutter 123, and the image sensor 124 of the optical block 101 on the basis of an operation signal supplied from the input section 185 according to the analysis value group (recognition result or statistical analysis result) obtained by the statistical analysis unit 105 and the recognition processing unit 106 or according to operation input from the key 43 and the touch panel 111.

More specifically, the camera control unit 108 includes the camera control front end 191, the AE (Auto Exposure) control section 192, the Driver 193, the AF (Auto Focus) control section 194, and the Driver 195.

The camera control front end 191 receives input of an operation signal supplied from the input section 185 according to analysis values obtained by the statistical analysis unit 105 and the recognition processing unit 106 or according to operation input from the key 43 and the touch panel 111, and outputs a control signal for controlling the actions of the lens 121, the shutter 123, and the image sensor 124 to at least any one of the AE control section 192 and the AF control section 194 on the basis of the received information.

The AE control section 192 controls the action of the Driver 193 for driving opening and closing of the shutter 123, on the basis of the control signal received from the camera control front end 191, and also adjusts sensitivity of the image sensor 124, for example, to control exposure associated with imaging.

The AF control section 194 controls the action of the Driver 195 for driving the lens 121, on the basis of the control signal received from the camera control front end 191, to control a focal position.

### <Functional Measuring Section>

Described next with reference to FIG. 9 will be a function achieved by the functional measuring section 145.

The functional measuring section 145 includes a plant filter 211, a leaf surface light intensity filter 212, a leaf surface light intensity estimation section 213, a chlorophyll fluorescence calculation section 214, a plant filter 215, and a leaf surface light intensity filter 216.

The plant filter 211 acquires NDVIs and PRIs calculated by the vegetation index calculation section 144, extracts, by filtering, PRIs corresponding to NDVIs having values falling within a predetermined range, and outputs the extracted PRIs to the leaf surface light intensity filter 212.

Specifically, a region such as soil other than plants is mixed in the measured range (the range of two-dimensional data). It is possible that, in this state, correct functions (of plants) cannot be evaluated.

Accordingly, the plant filter 211 extracts, by filtering, only a region where corresponding NDVIs fall within a predetermined range (e.g., NDVI>0.5) in a distribution indicating a region of PRIs to extract PRIs in a region of plants. The functions of the plants are thereby extracted as data allowing appropriate evaluation.

The leaf surface light intensity estimation section 213 estimates leaf surface light intensity (PAR: Photosynthetically Active Radiation) on the basis of spectral radiance, and outputs an estimation result to the leaf surface light intensity filters 212 and 216.

The leaf surface light intensity filter 212 performs filtering for extracting PRIs corresponding to leaf surface light intensity (PAR) as indexes indicating environmental responses in a region of a predetermined range, from the PRIs extracted and supplied from the plant filter 211, and outputs the extracted PRIs as the Filtered PRIs (environmental stress responses).

For example, in a case where such an environmental stress that stomata are closed by drought of the soil has been caused, the degree of stress actually imposed on the plants is greatly influenced by light intensity applied to the plants. Accordingly, in a case where a plurality of plants and leaves to which different levels of leaf surface light intensity are applied are present in the measurement range (e.g., the leaf surface light intensity is variable depending on whether or not the leaves face in the direction toward the sun), only the PRIs corresponding to leaf surface light intensity within a predetermined range are extracted, making it possible to output environmental stress responses from which the effect of leaf surface light intensity has been excluded.

The chlorophyll fluorescence calculation section 214 calculates chlorophyll fluorescence on the basis of spectral radiance, and outputs the calculated chlorophyll fluorescence to the plant filter 215.

The plant filter 215 acquires a chlorophyll fluorescence calculation result obtained by the chlorophyll fluorescence calculation section 214 and the NDVIs calculated by the vegetation index calculation section 144, extracts, by filtering, the chlorophyll fluorescence corresponding to the NDVIs having values within a predetermined range, and outputs the extracted chlorophyll fluorescence to the leaf surface light intensity filter 216.

Specifically, similarly to the plant filter 211, the plant filter 215 performs filtering for extracting only a region where corresponding NDVIs fall within a predetermined range in a distribution indicating a region of the chlorophyll fluorescence, to extract chlorophyll fluorescence in a region of plants. The chlorophyll fluorescence is thereby extracted as data allowing appropriate evaluation.

Similarly to the leaf surface light intensity filter 212, the leaf surface light intensity filter 216 performs filtering for extracting chlorophyll fluorescence indicating that values of leaf surface light intensity (PAR) fall within a predetermined range, from the chlorophyll fluorescence extracted and supplied from the plant filter 215, and outputs the extracted chlorophyll fluorescence as Filtered SIF (chlorophyll fluorescence).

### <3D Data Cube>

FIG. 10 illustrates an example of three-dimensional data that is generated by the spectral front end 131 and indicates a measurement target in a spatial direction (XY) and a wavelength direction (λ), i.e., a 3D data cube.

The 3D data cube is three-dimensional data of the measurement target in the spatial direction (XY) and the wavelength direction (λ). Coordinates of respective points on the surface of the measurement target are expressed by XY coordinates. Light intensity (λ) of wavelength light at each of coordinate positions (x, y) is recorded in the data. The data cube illustrated in the figure includes 8×8×8 cube-data. One cube represents data indicating light intensity of a specific wavelength (λ) at a specific position (x, y). Note that, in the present disclosure, the spectral radiance calculation section 132 obtains spectral radiance on the basis of the light intensity (λ) of the 3D data cube illustrated in FIG. 10 and formed by the spectral front end 131 and supplies, to the spectral application unit 103, the 3D data cube in the form in which each light intensity (λ) is replaced with the spectral radiance. Moreover, the spectral reflectance calculation section 141 having acquired the 3D data cube in the form replaced with spectral radiance calculates spectral reflectance on the basis of the spectral radiance, and supplies, to the RGB development section 143 and the vegetation index calculation section 144, the 3D data cube in the form replaced with the calculated spectral reflectance.

Note that the number 8×8×8 indicating the number of the cubes is presented only by way of example. This number is variable according to spatial resolution or wavelength resolution of the spectroscopic measurement device.

### Example Using Multi-Lens

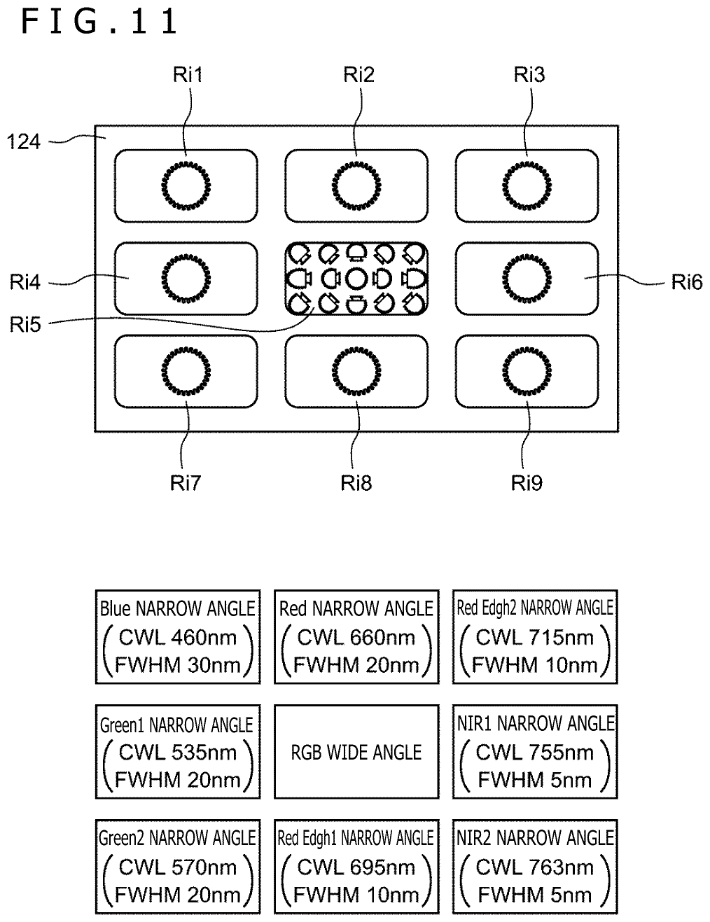

FIG. 11 is a diagram schematically illustrating an example of imaging regions Ri each formed for a corresponding lens of lenses provided on the image sensor 124 in a case of use of multi-lenses.

FIG. 11 illustrates an example of the imaging regions Ri in a case where the nine multi-lenses are provided by way of example. The imaging regions Ri each formed for the corresponding lens are given numerals 1 to 9 at ends of the respective reference signs to distinguish the imaging regions Ri from each other.

An upper part of FIG. 11 schematically illustrates an arrangement example of the imaging regions Ri1 to Ri9 on the image sensor 124, while a lower part of FIG. 11 illustrates an example of details of a characteristic and an angle of view of a wavelength filter provided on an optical path for each of the imaging regions Ri, i.e., for each of the lenses.

According to the example in FIG. 11, only the imaging region Ri5 located at the center in the imaging regions Ri1 to Ri9 has a wide angle, while each of the other imaging regions Ri has a narrow angle. In a case where the measurement target is a tree, for example, as illustrated in the upper part in FIG. 11, images of a plurality of images of trees are included in the imaging region Ri5 having a wide angle. Meanwhile, only a smaller number of images of trees, such as one, for example, than that number in the case of the wide angle are included in each of the imaging regions Ri each having a narrow angle.

Moreover, according to the example in FIG. 11, the imaging region Ri1 belongs to a wavelength classification of “Blue,” and a wavelength filter having a CWL (Center Wavelength)=460 nm and an FWHM (Full Width at Half Maximum)=30 nm is adopted, for example. Further, the imaging region Ri2 belongs to a wavelength classification of “Red,” and a wavelength filter having a CWL=660 nm and an FWHM=20 nm is adopted, for example.

In addition, the imaging region Ri3 belongs to a wavelength classification of “Red Edgh2,” and a wavelength filter having a CWL=715 nm and an FWHM=10 nm is adopted, for example. The imaging region Ri4 belongs to a wavelength classification of “Green1,” and a wavelength filter having a CWL=535 nm and an FWHM=20 nm is adopted, for example.

The imaging region Ri5 having a wide angle belongs to a wavelength classification of “RGB,” and an RGB filter is used as a wavelength filter.

The RGB filter herein is a wavelength filter which transmits and separates light in R, light in G, and light in B for each pixel of the image sensor 124. This wavelength filter functioning as the RGB filter is provided as a set of on-chip color filters disposed for each pixel of the image sensor 124.

According to this example, the wavelength filter for each of the imaging regions Ri except for the imaging region Ri5 in the imaging regions Ri1 to Ri9 is such a wavelength filter which filters wavelengths in a predetermined wavelength band of entire irradiation light applied to the corresponding imaging region Ri as described above.

The imaging region Ri6 belongs to a wavelength classification of “NIR1,” and a wavelength filter having a CWL=755 nm and an FWHM=5 nm is adopted, for example. The imaging region Ri7 belongs to a wavelength classification of “Green2,” and a wavelength filter having a CWL=570 nm and an FWHM=20 nm is adopted, for example.

In addition, the imaging region Ri8 belongs to a wavelength classification of “Red Edgh1,” and a wavelength filter having a CWL=695 nm and an FWHM=10 nm is adopted, for example. The imaging region Ri9 belongs to a wavelength classification of “NIR2,” and a wavelength filter having a CWL=763 nm and an FWHM=5 nm is adopted, for example.

Note that a wavelength filter having a CWL=757 nm and an FWHM=1 nm can also be adopted for “NIR1” described above, and that a wavelength filter having a CWL=761 nm and an FWHM=1 nm can also be adopted for “NIR2” described above.

While FIG. 11 illustrates the example where the respective imaging regions Ri have the same size (corresponding to an image circle size) herein, the imaging region Ri of at least one of the lenses may have a size different from the size of the imaging regions Ri of the other lenses.

There is a possibility that not only the angle of view but also resolution or a length-to-width ratio to be obtained is variable for each lens (each wavelength). Moreover, the respective imaging regions Ri on the image sensor 124 are required to be disposed at geometrically appropriate positions according to the shape of the image sensor 124.

In the configuration where the imaging region Ri of at least one of the lenses has a size different from the size of the imaging regions Ri of the other lenses as described above, appropriate resolution or an appropriate length-to-width ratio of the imaging region Ri can be set for each lens. In addition, the imaging regions Ri of the respective lenses can be disposed at appropriate positions according to the shape of the image sensor 124.

Moreover, while the example in FIG. 11 is the case where the lenses have different angles of view for the different transmission wavelength bands provided by the wavelength filters, the lenses may have different angles of view for the same transmission wavelength band provided by the wavelength filters.

Note that the imaging regions Ri1 to Ri4 and Ri6 to Ri9 in FIG. 11 can be aligned and overlapped with each other to form substantially the same configuration as the 3D cube data described above. Accordingly, it is assumed in the description of the present disclosure that the spectral front end 131 creates the 3D data cube, and that the spectral radiance calculation section 132 replaces respective values of light intensity with respective values of spectral radiance.

### (PRI)

Described next will be a PRI and PAR included in vegetation indexes calculated by the functional measuring section 145.

The PRI (Photochemical Reflectance Index) is an index for measuring a stress response of a plant to each of various types of stress factors, and is calculated by the following equation (3) in general.

$$P R I = ( ρ 531 - ρ 570 ) / ( ρ 531 + ρ 570 ) \qquad ( 3 )$$

In this equation, ρ531 represents spectral reflectance at a wavelength of approximately 531 nm, while ρ570 represents spectral reflectance at a wavelength of approximately 570 nm.

It is considered that a degree of epoxidation/de-epoxidation in a xanthophyll cycle is optically detected on the basis of the PRI. Accordingly, in consideration of the foregoing mechanism, the PRI is expected to be available as an index for measuring a stress response of a plant to each of various types of stress factors.

### (Leaf Surface Light Intensity PAR)

Leaf surface light intensity PAR (photosynthetically Active Radiation) is light intensity of energy around a range from 400 nm to 700 nm, which range is available for photosynthesis. A larger radiation amount is available for photosynthesis as the PAR increases.

Reflectance of a leaf can be estimated in a rough range. Accordingly, measurement of the leaf surface light intensity PAR is achieved from measured radiance of a leaf by performing the following procedures estimated on the basis of assumed reflectance. Note that the leaf surface light intensity PAR is variable according to a direction of each leaf with respect to sunlight, and therefore is a value including some variations.

First, when images of respective values of intensity of PAR and NIR on the standard diffuse reflection plate are captured by the image sensor 124, respective readout values from the image sensor 124 are corrected with calibration values, these corrected values are obtained as measurement values A and B, and also a ratio A/B is calculated.

Moreover, when an image of intensity of NIR on a leaf surface is captured by the image sensor 124, a readout value from the image sensor 124 is corrected with a calibration value, and this corrected value is measured as a measurement value C.

Assuming that reflectance of NIR of the leaf is ρ_{NIR} herein, it is estimated that light intensity of NIR on the leaf surface is C/ρ_{NIR}. With use of this value and the ratio of PAR to NIR, i.e., A/B, on the standard diffuse reflection plate, leaf surface light intensity PAR is calculated as (C/ρ_{NIR})×(A/B).

### Display Example

Described next with reference to FIGS. 12 to 25 will be a display example of a synthetic image synthesized by the image synthesizing section 182 on the basis of a RGB image group and an analysis value group generated by the spectral application unit 103, the visualization unit 104, the statistical analysis unit 105, and the recognition processing unit 106, and displayed on the LCD 42 by the image output section 181.

### Display Example of RGB Image

The RGB development section 143 of the spectral application unit 103 forms an RGB image by performing a conversion process which uses a standard relative spectral sensitivity curve specified by CIE (Commission Internationale de l'eclairage), on the basis of spectral radiance supplied from the spectral radiance calculation section 132 of the spectral processing unit 102.

Note that the RGB development section 143 may adopt an RGB sensitivity curve of a typical image sensor to achieve conversion compatible with color reproducibility of existing cameras.

The RGB development section 143 forms an RGB image Prgb which is a captured image of a leaf illustrated in FIG. 12, for example, on the basis of spectral reflectance calculated by the spectral reflectance calculation section 141 from spectral radiance supplied from the spectral radiance calculation section 132 of the spectral processing unit 102. The image synthesizing section 182 displays the RGB image supplied from the RGB development section 143, as necessary without change.

In addition, in a case where the whiteboard identification section 173 detects a whiteboard corresponding to the standard diffusion plate from the RGB image Prgb at this time, a frame SRB is synthesized and displayed at the position where the standard diffusion plate has been detected as indicated in a lower left part of FIG. 12.

### Display Example of Color Map Image

### (Color Map Image Based on PRI)

The visualization unit 104 forms a visualized color map image by adding colors, with use of the color map 151, to various types of vegetation indexes and invisible two-dimensional data of leaf surface light intensity output from the vegetation index calculation section 144 and the functional measuring section 145 of the spectral application unit 103.

For example, in a case where calculated PRIs are supplied, the visualization unit 104 maps RGB three primary colors by using the color map 151 for visualization with naked eyes. Note that, needless to say, gray scaling may be adopted.

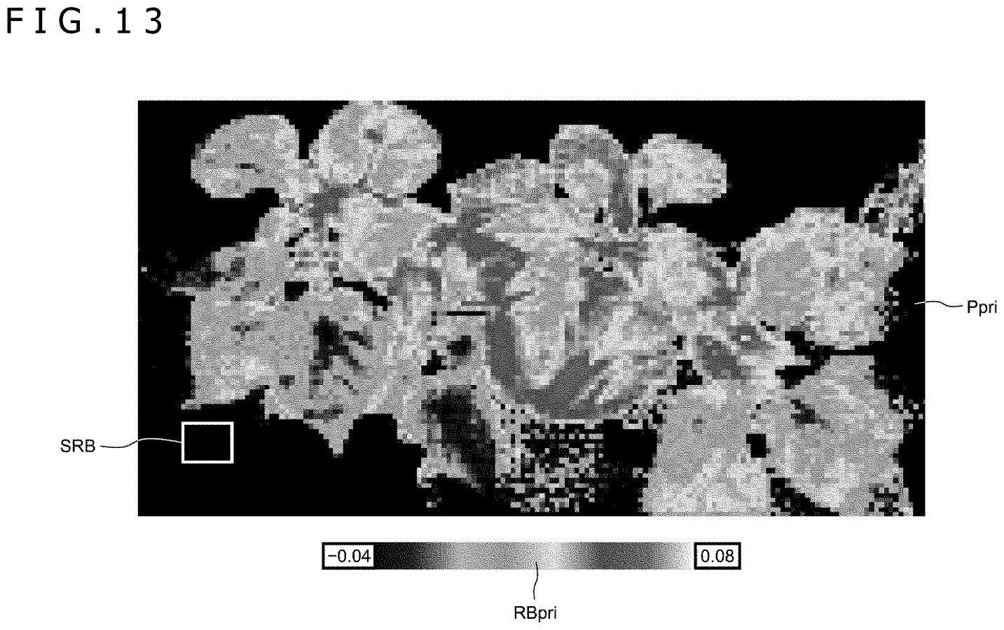

FIG. 13 is a color map image Ppri formed by applying color mapping based on the color map 151 to invisible two-dimensional data including the PRIs at an angle of view corresponding to the RGB image in FIG. 12.

A color map bar RBpri representing mapped colors in association with numerical values of the PRIs is displayed in a lower part of the figure. It is indicated that the minimum value is −0.04, and that the maximum value is 0.08.

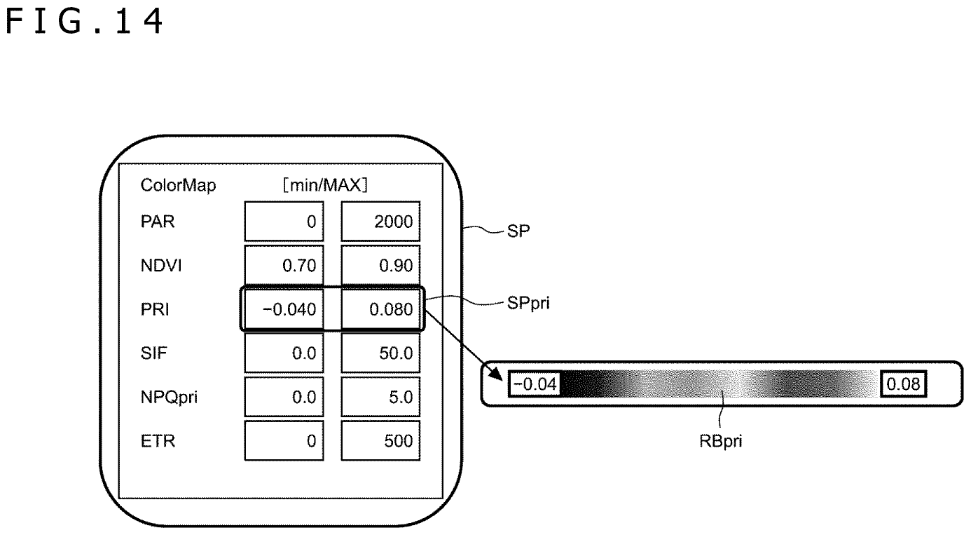

For example, a correlation between the numerical values and the minimum and maximum values of the color map can be set by the user through a setting image SP illustrated in FIG. 14.

The setting image SP includes setting columns corresponding to the types of the invisible two-dimensional data. In FIG. 13, a PRI setting column SPpri is surrounded by a bold frame, and the minimum value (min) is −0.040, while the maximum value (MAX) is 0.080. A display example of the color map bar RBpri corresponding to this state is presented.

Moreover, setting columns are provided for PAR, NDVI, PRI, SIF, others, NPQpri, . . . , ETR, . . . in this order from top in the figure. A maximum value and a minimum value may also be set for each.

A range of each numerical value of pixels constituting the invisible two-dimensional data is variable according to a measurement target. Accordingly, these numerical values may be set on the basis of a calculation result obtained by calculation of the maximum value and the minimum value of each of the numerical values in one designated screen, or may be set on the basis of a calculation result obtained by calculation of the maximum value and the minimum value in the image group when an image group including a plurality of images are designated. The visualization unit 104 forms these images in real time, and outputs the formed images to the image synthesizing section 182. The image synthesizing section 182 causes the LCD 42 to display, via the image output section 181, the color map image formed by the visualization unit 104, as necessary without change.

### (Color Map Image Based on Leaf Surface Light Intensity PAR)

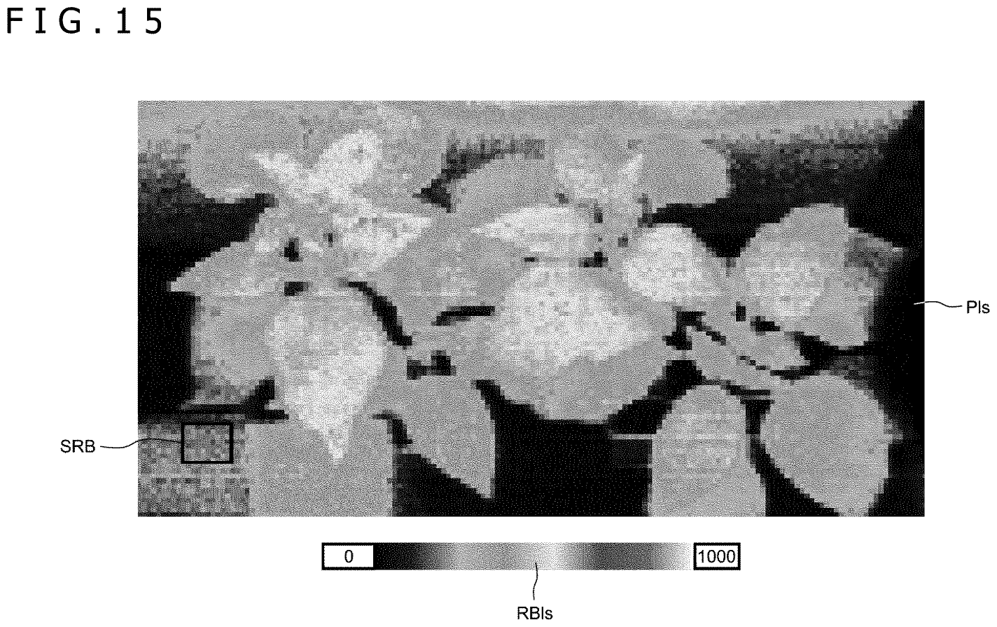

FIG. 15 is a color map image Pls formed by applying color mapping based on the color map 151 to leaf surface light intensity PAR at an angle of view corresponding to the RGB image in FIG. 12.

Displayed in a lower part of the figure is a color map bar RBls representing mapped colors in association with numerical values of the leaf surface light intensity PAR. It is indicated that the minimum value is 0, and that the maximum value is 1000.

For example, a correlation between the numerical values and the minimum and maximum values of the color map can be set by the user through a setting image SP illustrated in FIG. 14.

The visualization unit 104 forms these images in real time, and outputs the formed images to the image synthesizing section 182. The image synthesizing section 182 causes the LCD 42 to display, via the image output section 181, the color map image formed by the visualization unit 104, as necessary without change.

### <Filtering Process>

### (Plant Filter)

The RGB image as a visualized image based on the invisible two-dimensional data including the PRIs described above also includes the soil or the like other than plants. Accordingly, it is preferable that an unnecessary region be excluded by a filter in a case of visualized display or statistical analysis as well. In this case, the region other than plants can be excluded with use of NDVIs, for example.

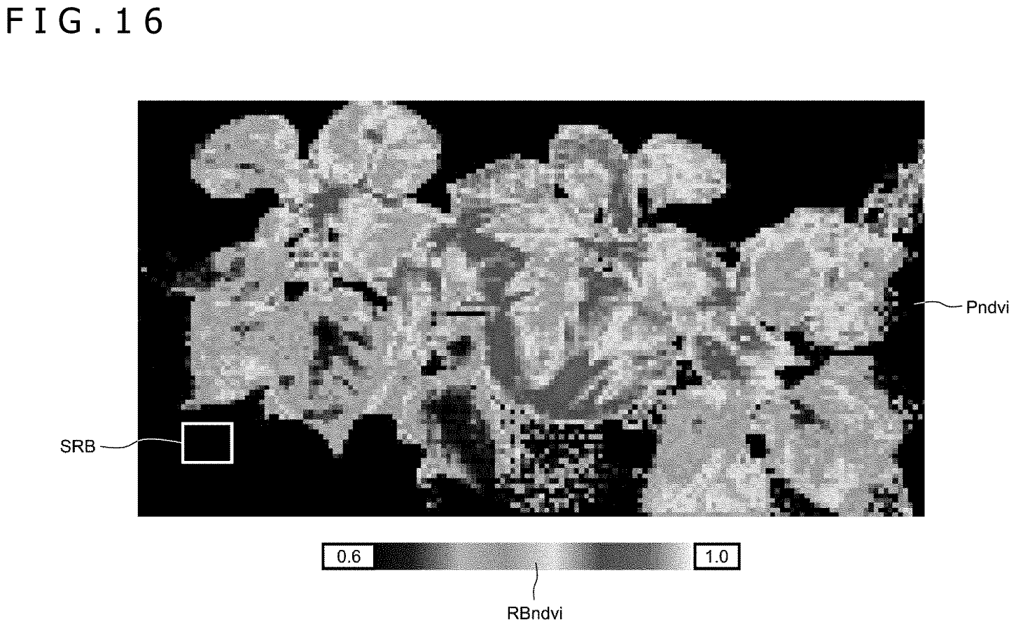

FIG. 16 is a display example of a color map image Pndvi in a case where NDVIs are supplied as invisible two-dimensional data at an angle of view corresponding to the RGB image Prgb as a visualized image in FIG. 12.

Similarly to the above, a color map bar RBndvi which represents mapped colors in association with numerical values of NDVIs is displayed in a lower part of FIG. 16. It is indicated that the minimum value is 0.6, and that the maximum value is 1.0.

It is apparent from FIG. 16 that a range displayed in a blackish color is a region where something other than plants is present from a comparison with FIG. 12.

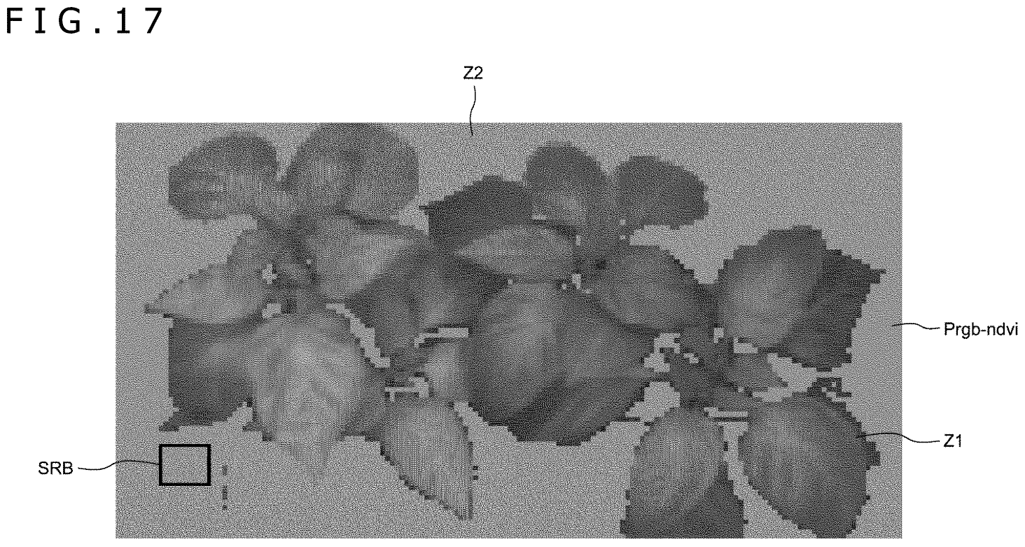

Specifically, a region where NDVIs are lower than a predetermined value in FIG. 16 is a range where something other than plants is present. Accordingly, as illustrated in an RGB image Prgb-ndvi in FIG. 17, for example, the image synthesizing section 182 masks a region Z2 which is included in the RGB image Prgb in FIG. 12 and where NDVIs are lower than the predetermined value by arranging a predetermined color, and applies filtering such that the RGB image Prgb in FIG. 12 is displayed only in a region Z1 other than the region Z2 to form a synthetic image.

In such a manner, only the region Z1 where plants are present can be displayed as an RGB image. Similarly, only the region Z1 where plants are present can be extracted and used for statistical analysis.

### (Other Filtering)

While described above is the filtering process based on NDVIs, other types of invisible two-dimensional data may be employed.

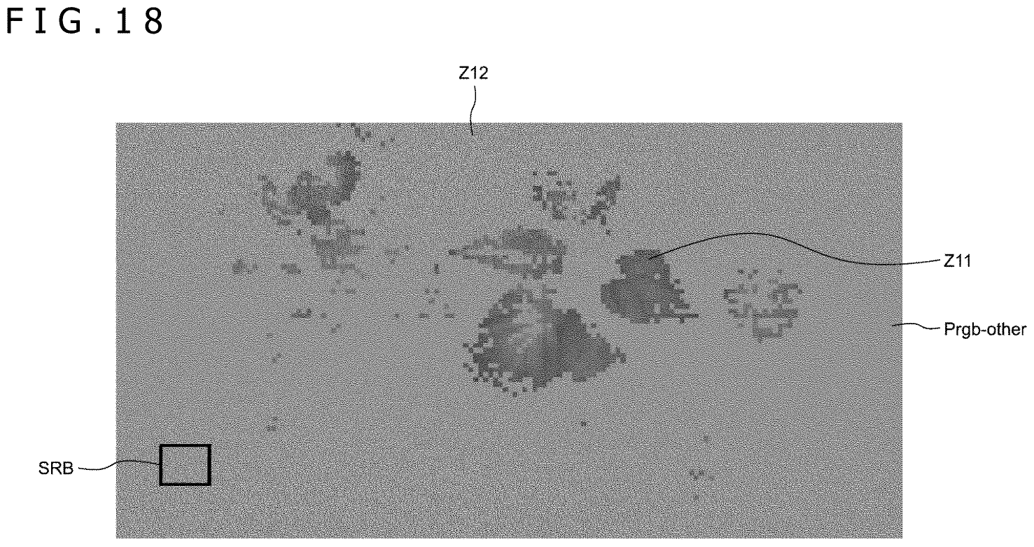

FIG. 18 illustrates a display example of an RGB image Prgb-other formed by filtering based on invisible two-dimensional data including a factor other than NDVIs, such as leaf surface light intensity, which falls within a fixed range.

In FIG. 18, a region Z12 exhibiting lower values or higher values than a predetermined value in predetermined invisible two-dimensional data is masked. The RGB image Prgb in FIG. 12 is displayed in a region Z11 other than the region Z12.

In such a manner, only the region Z11 exhibiting the lower values or the higher values than the predetermined value in the predetermined invisible two-dimensional data can be displayed as the RGB image. In addition, only the region Z1 exhibiting the lower values or the higher values than the predetermined value in the invisible two-dimensional data can be extracted and used for statistical analysis.

### <Synthesis of Visible Data and Invisible Data>

While described above is the example of the RGB image as visible data and the color map image visualized for each invisible two-dimensional data, an image visualized on the basis of invisible two-dimensional data may be superimposed and synthesized on visible data and displayed.

FIG. 19 illustrates a display example of an RGB image Prgb-pri including PRIs extracted using a plant filter (NDVI: predetermined value or lower) and a leaf surface intensity filter from the color map image Ppri in FIG. 13 and converted into a color map on the RGB image Prgb in FIG. 12.

As illustrated in FIG. 19, the image synthesizing section 182 synthesizes a region Z21 exhibiting larger values of PRIS than a predetermined value in the color map image Ppri in FIG. 13 and a region Z22 constituted by the RGB image Prgb in FIG. 12 into the RGB image Prgb-pri.

Such display enables identification of only an environmental stress response of a leaf exhibiting fixed leaf surface light intensity in the RGB image Prgb displayed on the LCD 42, and therefore achieves appropriate imaging of a desired imaging target with appropriate exposure adjustment and appropriate focus adjustment.

Note that, in general, environmental stress responses include, in addition to a response caused by water stress resulting from a water shortage, a response caused by excessively high leaf surface light intensity. Accordingly, if regions having caused environmental stress responses are displayed without distinction between a region that corresponds to high leaf surface light intensity and that can cause an environmental stress response resulting from leaf surface light intensity and other regions, for example, it is difficult to distinguish between a region having caused an environmental stress response as a result of water stress and a region having caused an environmental stress response as a result of leaf surface light intensity.

Accordingly, as indicated in the RGB image Prgb-pri illustrated in FIG. 19, the regions having caused stresses are identified after filtering regions that is unlikely to cause stresses resulting from leaf surface light intensity, making it possible to clearly identify the regions causing water stress.

### <Statistical Analysis Unit>

The statistical analysis unit 105 statistically analyzes invisible two-dimensional data output from the spectral application unit 103, and converts an analysis result into a graph.

More specifically, the statistical analysis unit 105 includes the statistical analysis section 161 and the graph generation section 162.

The statistical analysis section 161 statistically analyzes invisible two-dimensional data, and outputs an analysis result to the graph generation section 162.

The graph generation section 162 generates a graph on the basis of the statistical analysis result of the invisible two-dimensional data supplied from the statistical analysis section 161, and outputs the generated graph.

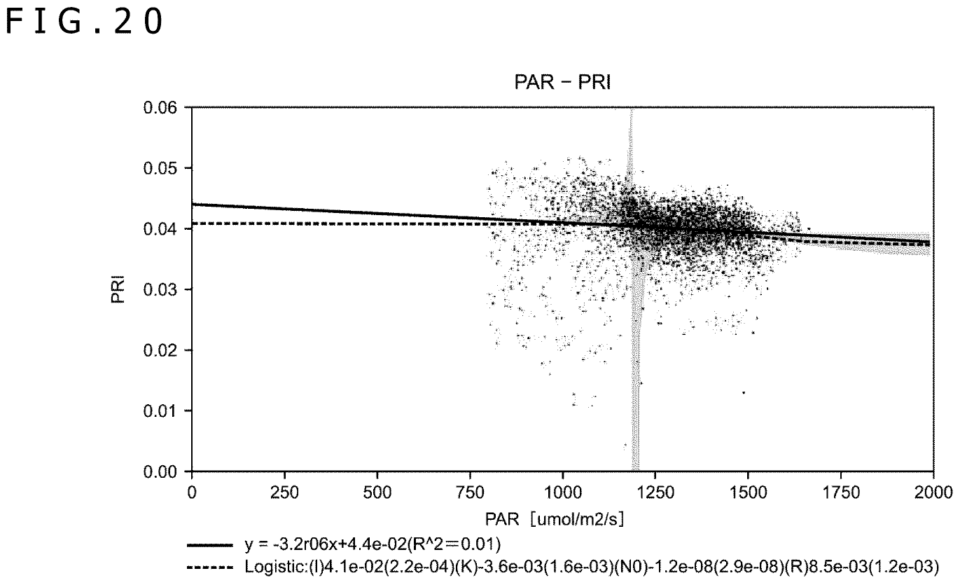

For example, as illustrated in FIG. 20, the graph generation section 162 generates a graph image including a scatter plot which has a horizontal axis representing input (leaf surface light intensity PAR) and a vertical axis representing output (PRI), on the basis of leaf surface light intensity PAR and PRIs supplied from the statistical analysis section 161.

Moreover, the statistical analysis section 161 performs regression of an appropriate function (primary function, quadratic function, logistic function, or any function), while the graph generation section 162 displays parameters of the function on the graph image as a result of the regression.

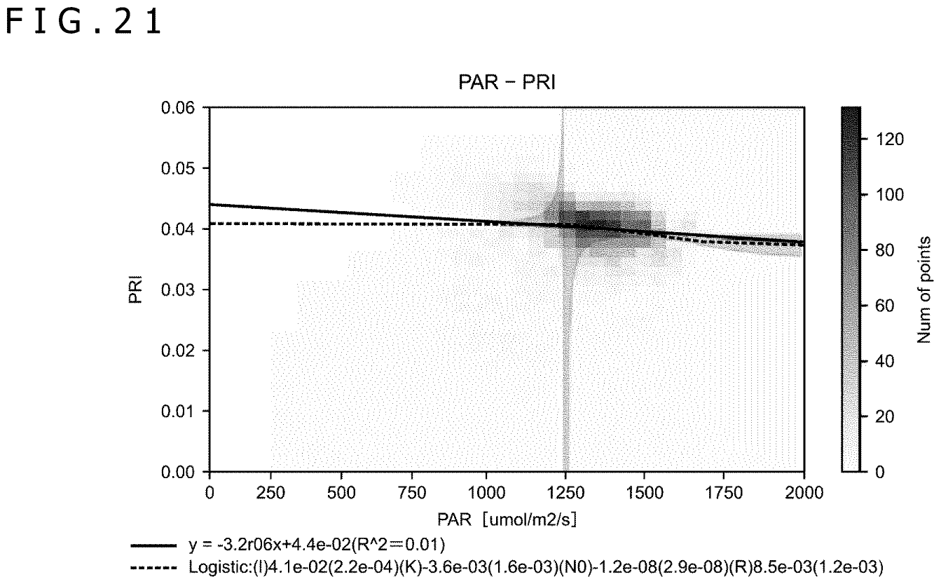

Further, for example, the graph generation section 162 forms a graph image including a heat map on the basis of similar data as illustrated in FIG. 21.

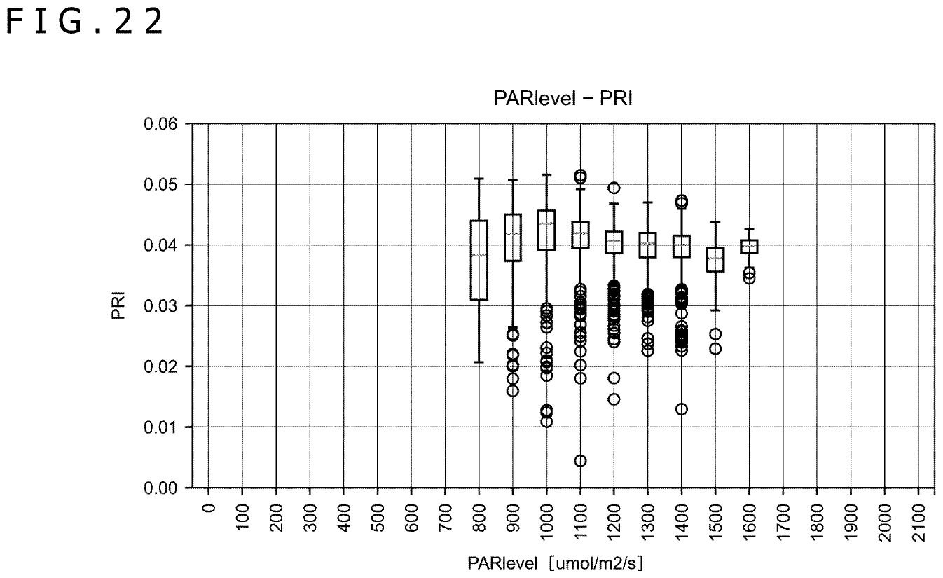

In addition, for example, the graph generation section 162 forms a graph image including a box-and-whisker graph illustrated in FIG. 22.

Note that these graph images may be displayed on independent screens, or may be superimposed on an RGB image or other color map images displayed on a live view screen, to provide the graph images as sub-screens.

### <Designation of ROI Region>

A predetermined region on the screen may be designated by operating the touch panel 111, the key 43, or the like to display numerical values (obtained by processing) for the designated region. Moreover, conversion into a graph based on a statistical analysis result may be updated according to this designation.

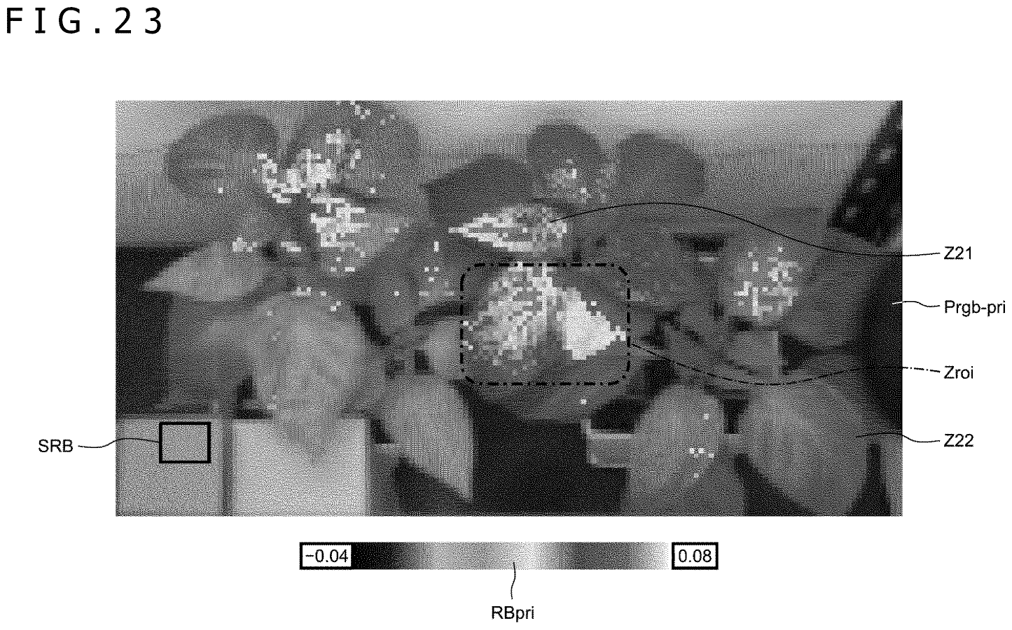

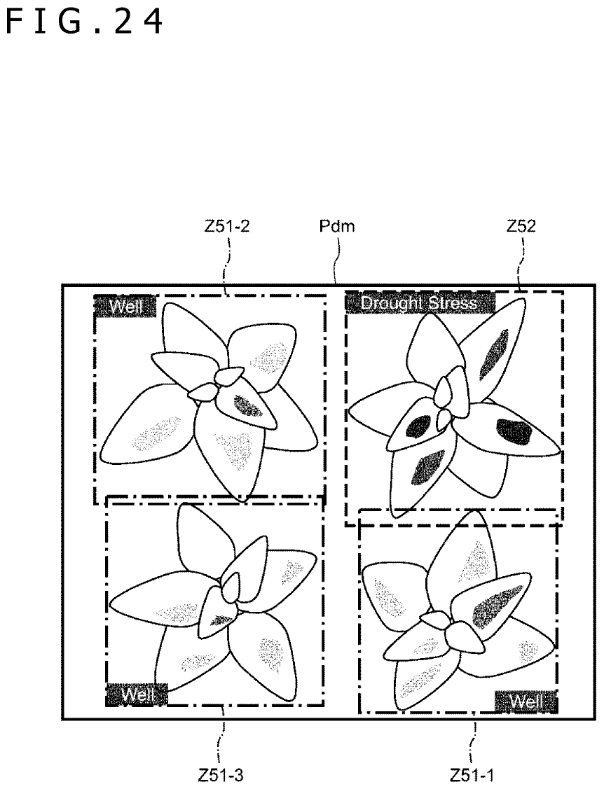

As illustrated in FIG. 23, an average value of predetermined invisible two-dimensional data, such as an average value of PRI values, in a region Zroi designated by the user as an ROI (Region of Interest) region can be calculated and displayed on the RGB image Prgb-pri illustrated in FIG. 19.

Specifically, as illustrated in FIG. 23, in a case where the region Zroi is designated as the ROI region by operating the touch panel 111, the statistical analysis section 161 executes statistical analysis corresponding to the designated region Zroi.

The graph generation section 162 forms a graph image on the basis of a statistical analysis result corresponding to the region Zroi.

In addition, the position and the size of a region of the frame SRB corresponding to the position of the standard diffuse reflection plate may be designated by the user by a similar method.

<Display with Highlight>

As described above, for designating the ROI region by operating the touch panel 111 or the key 43, the user is required to hold the imaging device 31 and operate the touch panel 111 and the key 43 while viewing a subject, and detailed designation of the position and the size is limited.

According to the present disclosure, therefore, the state identification section 172 of the recognition processing unit 106 may highlight a region identified as a state higher or lower than a predetermined threshold on the basis of invisible two-dimensional data output from the spectral application unit 103. In this manner, the user is enabled to easily recognize the measurement target.

More specifically, for example, the image synthesizing section 182 causes the state identification section 172 to highlight the region which is in the state higher or lower than the predetermined threshold in the invisible two-dimensional data as illustrated in FIG. 24, for example.

An image Pdm in FIG. 24 presented as an example of display with highlight is an image in which a region exhibiting a higher value than a predetermined value and regions exhibiting lower values than the predetermined value in a color map image are superimposed on an RGB image, the color map image being obtained by applying color mapping thereto according to numerical values of leaf surface light intensity PAR indicating intensity of stress associated with plants.

In the image Pdm in FIG. 24, regions each exhibiting a small value (low stress) in the leaf surface light intensity PAR, the value being smaller than a predetermined value determined as a normal region, are highlighted with frames Z51-1 to Z51-3 indicated by one-dot chain lines with a sign “well,” while a region exhibiting a large value (high stress) and determined as an abnormal region is highlighted with a frame Z52 corresponding to a stress detection frame indicated by a dotted line with a sign “Drought Stress?”

On the basis of such a manner of display, the user is enabled to appropriately recognize the high-stress region and the low-stress regions by viewing the image Pdm. When desiring to designate the low-stress regions as an imaging target, for example, the user can capture, as the imaging target, images of the regions highlighted with the frames Z51-1 to Z51-3 indicated by the one-dot chain lines, to appropriately capture the images of the imaging target.

Conversely, when desiring to designate the high-stress region as an imaging target, the user can capture, as the imaging target, an image of the region highlighted with the frame Z52 indicated by the dotted line, to appropriately capture the image of the imaging target.

Moreover, these highlighted regions may be designated as ROIs. In this case, the statistical analysis section 161 may regard the highlighted regions as ROI regions, and perform statistical analysis based on invisible two-dimensional data associated with only the highlight regions.

Further, the state identification section 172 may perform an image recognition process for an RGB image and a color map image in addition to the determination based on the numerical values of the leaf surface light intensity PAR described above. In this case, the state identification section 172 may search for a feature region by image recognition, identify and cluster the feature region, and perform state identification associated with only the clustered feature region.

For example, the state identification section 172 may recognize only leaves, specific types of plants, or plants having specific colors and shapes by performing the image recognition process, and achieve state identification of only leaves, a feature region where specific types of plants are present, or a feature region where such plants whose shapes or colors have been changed into specific shapes or colors are present.

In addition, in a case where any diagnosis is acquirable from a statistical analysis result obtained by the statistical analysis section 161, diagnosis information may also be highlighted. For example, in a case where a soil moisture sensor is included in the external sensor and indicates a small measurement value of soil moisture of plants corresponding to the imaging target and located at the position of the soil moisture sensor, a region exhibiting high environmental stress may be highlighted to indicate a possibility that the environmental stress has been caused by water stress when an environmental stress response obtained by functional measurement has a high value.

### <Individual Identification Section>

The individual identification section 171 may identify respective individuals of plants by image recognition using an RGB image and a color map image, and display the individuals on an LCD screen with identification IDs given to the individuals.

In this case, the individual identification section 171 may further break down the individuals into units such as leaves and stems of plants. Moreover, the individual identification section 171 may set ROIs according to identified regions.

Further, in a case where the imaging device 31 includes a GPS, an IMU (accelerometer, azimuth sensor, etc.), or the like, the individual identification section 171 may recognize where an imaging target is located on the GIS, on the basis of angle of view information, and associate GIS information with individual information with each other to, for example, attach a tag.

The tagging may be manually achieved by the user, or identification ID labels as identification indexes each disposed near the corresponding individual beforehand (e.g., identification ID labels such as two-dimensional barcodes) may be inserted into a screen at the time of measurement (imaging) to achieve identification.

These types of tag information may be attached to output image data as with Exif tags, or may be automatically classified for each folder for storage in the recording device 112. Alternatively, at the time of data transmission by the communication device 113, the data may be transmitted while switched on the destination side according to tag information.

Moreover, the individual identification section 171 may designate an individual and display the designated individual in a list of elapses of time as a function for sorting necessary data from stored data and displaying the sorted data.

Further, the individual identification section 171 may designate two individuals, display one of these as a comparison reference sample, select the other as a sample of interest in which any phenomenon may have been caused, and display the two individuals in left and right parts of one screen side by side, to display a comparison image allowing comparison.

Specifically, the comparison image is such an image as the one illustrated in FIG. 5, for example.

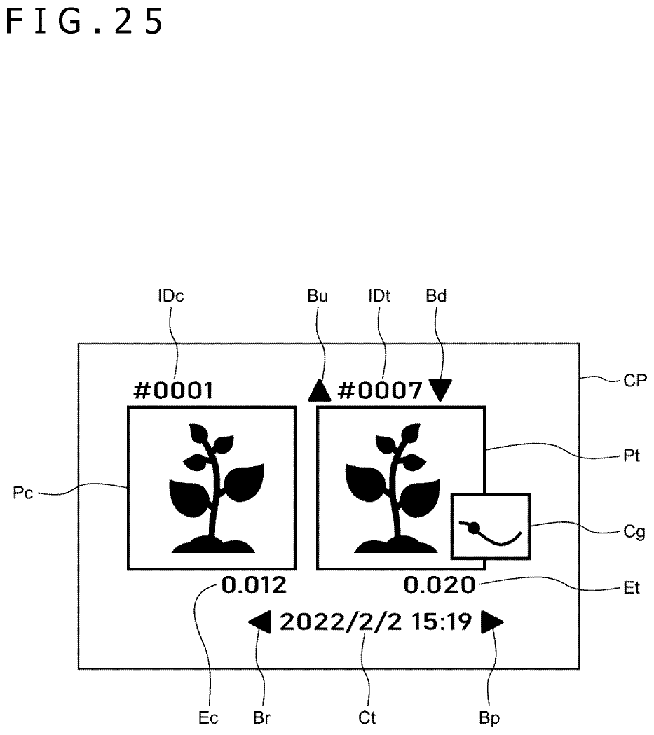

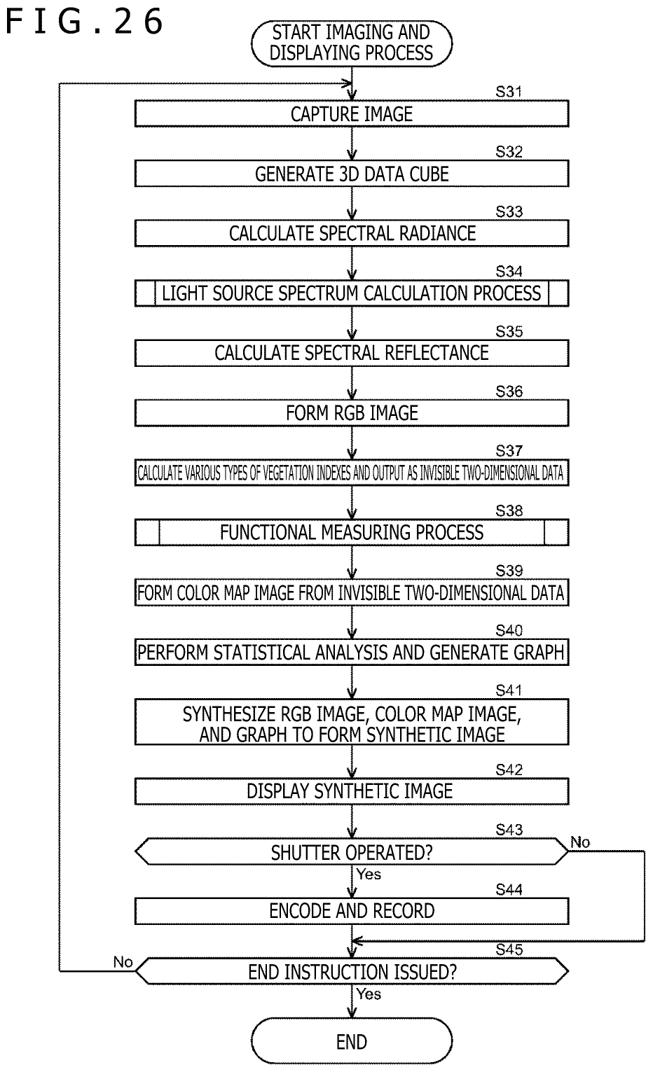

A comparison image CP in FIG. 25 includes an image display column Pc in a left part for displaying an individual corresponding to a comparison reference sample and an image display column Pt in a right part for displaying an individual corresponding to a sample of interest side by side, and has a configuration allowing visual comparison between the left and right parts.

A display column IDc displaying an identification ID for identifying the individual corresponding to the comparison reference sample is provided above the image display column Pc displaying the individual corresponding to the comparison reference sample, while a display column IDt displaying an identification ID for identifying the individual corresponding to the sample of interest is provided above the image display column Pt displaying the individual corresponding to the sample of interest.

In FIG. 25, #0001 and #0007 are given in the display column IDc and the display column IDt, respectively, to indicate that the respective identification IDs are #0001 and #0007.

Buttons Bu and Bd operated to switch the identification ID are provided on the left and right sides of the display column IDt, respectively. The button Bu is operated to decrease the value of the identification ID, and the button Bt is operated to increase the value of the identification ID. When the value of the identification ID is changed by operation of the button Bu or Bd, the image of the individual displayed in the image display column Pt is changed to an image corresponding to the identification ID and is displayed in the image display column Pt.

A display column Cg provided on the right side of the image display column Pt is a column where a graph is displayed to indicate a time-series change of invisible two-dimensional data, various types of statistical analysis results, and the like. A numerical value at the current time is represented as a circle in the graph of the display column Cg.

Display columns Ec and Et provided on the right side below the image display columns Pc and Pt, respectively, are columns where various types of numerical values are displayed. In FIG. 25, 0.012 and 0.020 are given in the columns Ec and Et, respectively.

A display column Ct provided in a lower right part of the comparison image CP is a column where time is displayed. In FIG. 25, “2022/2/2 15:19” is given to indicate that the images currently displayed in the image display columns Pc and Pt are captured at 15:19, Feb. 2, 2022 on the Western calendar.

Buttons Br and Bp are provided on the left and right side of the display column Ct, respectively. The button Br is operated to set the time forward, and the button Bp is operated to set the time backward. When the button Br or Bp is operated, the time in the display column Ct changes accordingly, and the images displayed in the image display columns Pc and Pt and the numerical values displayed in the display columns Ec and Et are changed to images and numerical values corresponding to information associated with the changed time and are displayed.

According to such a manner of display of the comparison image CP, one individual is displayed as a comparison reference sample, the other individual is selected as a sample of interest for which any phenomenon may have been caused, and the two individuals are displayed in the left and right parts of one screen side by side. Accordingly, visual comparison is achievable while switching the individuals and causing a time-series change.

While described above is the example which synthesizes vegetation indexes of plants (NDVIs and PRIs) and measurement results such as photosynthesis speeds and environmental stress responses with an RGB image to allow visual recognition of state information indicating internal states of plants, measurement results used for non-destructive inspection inside a different object on the basis of spectral images, for example, may be combined with an RGB image and displayed in this form.

For example, a position of concrete in an RGB image and a degree of an internal deterioration state at this position may be visually recognized on the basis of synthesis of a spectral measurement result in a calcium hydroxide absorption band of 1450 nm and the RGB image.

In addition, a synthetic image may be formed and presented by synthesizing an RGB image with not only vegetation indexes, photosynthesis speeds, and environmental stress responses of plants and a concrete deterioration state, but also state information indicating states of various measurement targets measurable on the basis of spectral images, or a graph image may be formed and synthesized by performing a statistical process.

As a result, the user is enabled to visually recognize various types of state information associated with a measurement target for each position on the basis of the synthetic images formed and presented as described above, and thus is enabled to select an appropriate measurement target and capture an image of the measurement target in an appropriate state.

### <Imaging and Displaying Process>

Described next with reference to a flowchart in FIG. 26 will be an imaging and displaying process performed by the imaging device 31 in FIG. 8.

Note that the process described with reference to the flowchart in FIG. 26 includes a series of processing from live view display of a subject to operation of the shutter at the time of imaging plants or the like corresponding to an observation target with use of the imaging device 31.

In step S31, the image sensor 124 captures an image in an optically light-separated state by using the lens 121, the spectral unit 122, and the shutter 123 of the optical block 101, and outputs the captured image to the spectral processing unit 102.

In step S32, the spectral front end 131 of the spectral processing unit 102 generates 3D data cube described with reference to FIG. 10, and outputs the generated 3D data cube to the spectral radiance calculation section 132.

In step S33, the spectral radiance calculation section 132 calculates spectral radiance on the basis of the 3D data cube, and outputs, to the spectral application unit 103, the 3D data cube whose normal spectral pixel values have been replaced with values of spectral radiance.

In step S34, the light source spectrum calculation section 142 executes a light source spectrum calculation process on the basis of the 3D data cube including the spectral radiance to calculate light source spectrums, and outputs the calculated light source spectrums to the spectral reflectance calculation section 141.

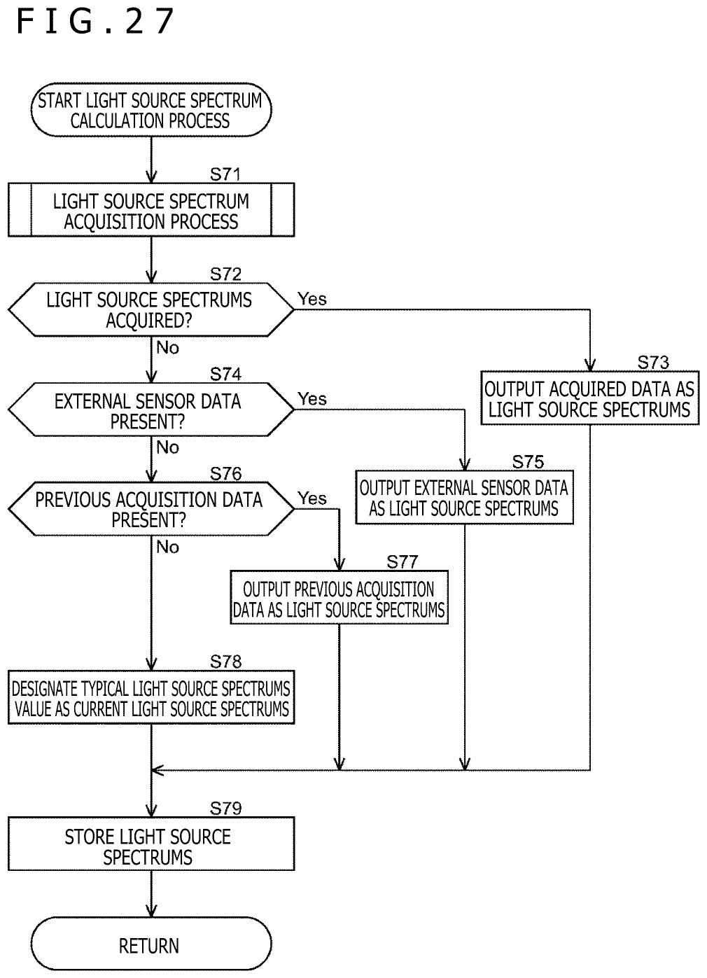

Note that details of the light source spectrum calculation process will be described below with reference to a flowchart in FIG. 27.

In step S35, the spectral reflectance calculation section 141 calculates spectral reflectance on the basis of the 3D data cube including the spectral radiance and the light source spectrums supplied from the light source spectrum calculation section 142, and outputs 3D data cube including the spectral reflectance to the RGB development section 143 and the vegetation index calculation section 144.

In step S36, the RGB development section 143 forms an RGB image on the basis of the 3D data cube including the spectral reflectance, and outputs the formed RGB image to the recognition processing unit 106 as well as the image synthesizing section 182 and the recording section 183 of the system control unit 107.

In step S37, the vegetation index calculation section 144 calculates various types of vegetation indexes on the basis of the spectral reflectance. For example, the vegetation index calculation section 144 calculates vegetation indexes including NDVIs on the basis of reflectance of near infrared light and spectral reflectance of red light to constitute invisible two-dimensional data, and outputs the invisible two-dimensional data to the functional measuring section 145, the visualization unit 104, the statistical analysis unit 105, and the recognition processing unit 106.

Moreover, for example, the vegetation index calculation section 144 calculates vegetation indexes including PRIs on the basis of spectral reflectance at a wavelength of approximately 531 nm and spectral reflectance at a wavelength of approximately 570 nm to constitute invisible two-dimensional data, and outputs the invisible two-dimensional data to the functional measuring section 145, the visualization unit 104, the statistical analysis unit 105, and the recognition processing unit 106.

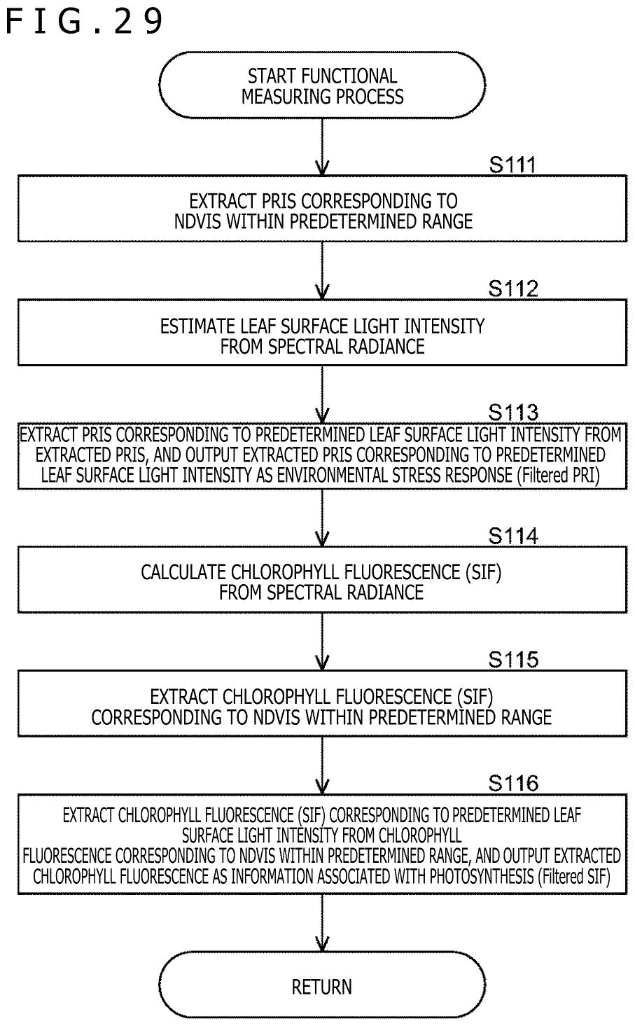

In step S38, the functional measuring section 145 executes a functional measuring process to constitute invisible two-dimensional data by measuring leaf surface light intensity PAR, chlorophyll fluorescence, and the like on the basis of spectral radiance and the vegetation indexes and calculating photosynthesis speeds and environmental stress responses, and outputs the invisible two-dimensional data to the visualization unit 104, the statistical analysis unit 105, and the recognition processing unit 106. Note that details of the functional measuring process will be described below with reference to a flowchart in FIG. 29.

In step S39, the visualization unit 104 applies color mapping to the various types of invisible two-dimensional data by using the color map 151 to form a color map image, and outputs the color map image to the image synthesizing section 182 and the recording section 183.

The visualization unit 104 forms the color map image on the basis of the invisible two-dimensional data such as NDVIs, PRIs, photosynthesis speeds, and environmental stress responses by using the color map 151.

In step S40, the statistical analysis section 161 of the statistical analysis unit 105 statistically processes the invisible two-dimensional data, and outputs, as analysis values, a processing result to the image synthesizing section 182 and the recording section 183, and also to the graph generation section 162. The graph generation section 162 generates a graph on the basis of a statistical analysis result supplied from the statistical analysis section 161, and outputs the generated graph to the image synthesizing section 182 and the recording section 183 as an RGB image group.

For example, the statistical analysis section 161 statistically analyzes leaf surface light intensity PAR-PRI, and the graph generation section 162 generates a scatter plot, a heat map, a box-and-whisker graph, and the like of the leaf surface light intensity PAR-PRI as described with reference to FIGS. 20 to 22, on the basis of a statistical analysis result.

Note that the recognition processing unit 106 at this time controls the individual identification section 171, the state identification section 172, and the whiteboard identification section 173 to execute an individual identification process, a state identification process, and a whiteboard identification process, and outputs respective identification results to the image synthesizing section 182 and the recording section 183 of the system control unit 107 as well as the camera control front end 191 of the camera control unit 108.

In step S41, the image synthesizing section 182 synthesizes the RGB image, the color map image, the graph image, and the analysis values obtained by the statistical analysis section 161, to form a synthetic image, and outputs the synthetic image to the image output section 181.

For example, the image synthesizing section 182 forms a synthetic image by superimposing a color map image of PRIs and a color map image of NDVIs on the RGB image.

Moreover, for example, the image synthesizing section 182 extracts only information associated with a region exhibiting a higher value or a lower value than a predetermined value, on the basis of the color map images of PRIs and NDVIs, to extract only an image of the corresponding region from the RGB image, and forms a masking image with a predetermined pixel value for the other regions.

In addition, for example, the image synthesizing section 182 further synthesizes the synthetic image including the RGB image and the color map image with the graph image and the analysis values.

Further, the image synthesizing section 182 forms a synthetic image including highlight by displaying a frame or the like surrounding a region exhibiting a higher value or a lower value than a predetermined value, on the RGB image or the color map image on the basis of the vegetation indexes and the values of the photosynthesis speeds and the environmental stress responses.

In step S42, the image output section 181 displays the synthetic image on the LCD 42. Specifically, the color map image, the statistical analysis result, and the like based on the various types of vegetation indexes, the photosynthesis speeds, and the environmental stress responses in an image capturing region in a direction where the optical block 101 of the imaging device 31 faces are displayed on the LCD 42 as live view display by performing the foregoing series of processing.

In step S43, it is determined whether or not the shutter has been operated by operation of the touch panel 111, the key 43, or the like.

In a case of determination that the shutter has been operated by operation of the touch panel 111, the key 43, or the like in step S43, the process proceeds to step S44.

In step S44, the input section 185 notifies the camera control front end 191 of the fact that the shutter has been operated. In response to this notification, the camera control front end 191 instructs the AE control section 192 and the AF control section 194 to capture an image.

On the basis of this instruction, the AF control section 194 controls the Driver 195 to drive the lens 121 to achieve focus adjustment. Meanwhile, the AE control section 192 controls the Driver 193 to control opening or closing of the shutter 123 to capture an image by using the image sensor 124.

Thereafter, by performing the foregoing series of processing, the recording section 183 causes the recording device 112 to record an analysis value group, a RGB image group, and the like supplied from each of the spectral application unit 103, the visualization unit 104, the statistical analysis unit 105, and the recognition processing unit 106, or transmits these groups to an unillustrated external device via the communication device 113.

Note that, in a case of determination that the touch panel 111, the key 43, or the like has not been operated and the shutter has not been operated in step S43, the processing in step S44 is skipped, and the process proceeds to step S45.

In step S45, it is determined whether or not an end instruction of the action, such as cutoff of the power source, has been issued. In a case of determination that the end instruction is not issued, the process returns to step S31. In other words, the processing from step S31 to S45 is repeated to continue live view display until the end instruction is issued.

Thereafter, when the action end instruction such as cutoff of the power source is issued in step S45, the process ends.

By repeating the foregoing series of processing, a synthetic image including the RGB image, the color map image, the graph image of the statistical analysis result, and the like based on the various types of vegetation indexes, the photosynthesis speeds, and the environmental stress responses in the image capturing region within the visual field where the optical block 101 of the imaging device 31 faces are displayed on the LCD 42 as live view display.

In this manner, the various types of vegetation indexes, the photosynthesis speeds, and the environmental stress responses, which are conventionally considered as invisible information, are converted into color map images as visible information. Accordingly, the user can appropriately select an imaging target on the basis of the vegetation indexes, the photosynthesis speeds, and the environmental stress responses, and capture an image of the imaging target with appropriate exposure adjustment and appropriate focus adjustment, only by visually recognizing an image displayed on the LCD 42.

### <Light Source Spectrum Calculation Process>

The light source spectrum calculation process will be described next with reference to the flowchart in FIG. 27.

In step S71, the light source spectrum calculation section 142 executes a light source spectrum acquisition process to acquire light source spectrums.

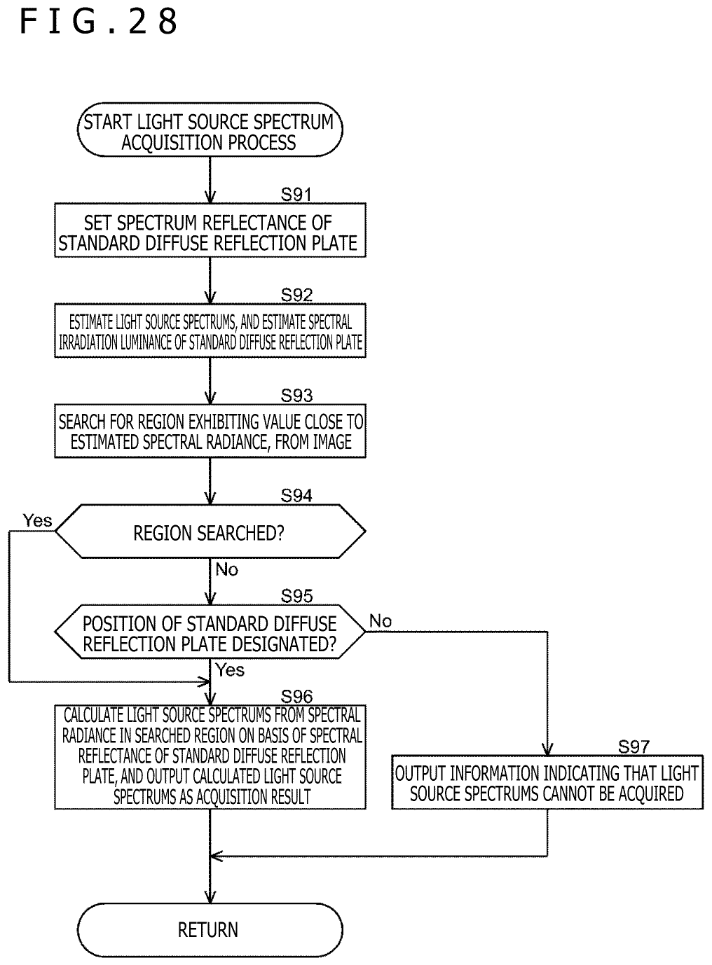

Note that details of the light source spectrum acquisition process will be described below with reference to a flowchart in FIG. 28.

In step S72, the light source spectrum calculation section 142 determines whether or not light source spectrums have been acquired by the light source spectrum acquisition process.

In a case of determination that the light source spectrums have been acquired in step S72, the process proceeds to step S73.

In step S73, the light source spectrum calculation section 142 outputs the acquired light source spectrums to the spectral reflectance calculation section 141, and the process proceeds to step S79.

In a case of determination that the light source spectrums have not been acquired in step S72, the process proceeds to step S74.

In step S74, the light source spectrum calculation section 142 determines whether or not the light source spectrums can be acquired as external sensor data via the external sensor input section 184.

In a case of determination in step S74 that the light source spectrums can be acquired as external sensor data, the process proceeds to step S75.

In step S75, the light source spectrum calculation section 142 outputs the light source spectrums acquired as the external sensor data to the spectral reflectance calculation section 141, and the process proceeds to step S79.

In a case of determination in step S74 that the light source spectrums cannot be acquired as the external sensor data, the process proceeds to step S76.

In step S76, the light source spectrum calculation section 142 determines whether or not previous acquisition data of the light source spectrums has been stored.

In a case of determination in step S76 that the previous acquisition data of the light source spectrums has been stored, the process proceeds to step S77.

In step S77, the light source spectrum calculation section 142 outputs the previous acquisition data of the light source spectrums to the spectral reflectance calculation section 141 as the acquired light source spectrums, and the process proceeds to step S79.

In a case of determination in step S76 that the previous acquisition data of the light source spectrums is not stored, the process proceeds to step S78.

In step S78, the light source spectrum calculation section 142 outputs typical light source spectrums to the spectral reflectance calculation section 141 as the acquired light source spectrums, and the process proceeds to step S79.

In step S79, the light source spectrum calculation section 142 stores the acquired light source spectrums as previous acquisition data to be used in the future. Thereafter, the process ends.

The light source spectrums are acquired and supplied to the spectral reflectance calculation section 141 by the foregoing process.

### <Light Source Spectrum Acquisition Process>

The light source spectrum acquisition process will be described next with reference to the flowchart in FIG. 28.

In step S91, the light source spectrum calculation section 142 sets spectral reflectance of the standard diffuse reflection plate.

For example, in a case where the reflection plate has fixed reflectance regardless of wavelengths, the light source spectrum calculation section 142 sets this reflectance. In a case where the reflection plate has reflectance variable for each wavelength and has known reflectance data, the light source spectrum calculation section 142 reads the known reflectance data.

In step S92, the light source spectrum calculation section 142 estimates light source spectrums, and estimates spectral irradiation luminance of the standard diffuse reflection plate.

In step S93, the whiteboard identification section 173 searches for a region exhibiting a value close to the estimated spectral radiance of the standard diffuse reflection plate, from an RGB image as the position of the standard diffuse reflection plate (whiteboard).

In step S94, the light source spectrum calculation section 142 determines whether or not the position of the standard diffuse reflection plate (whiteboard) has been searched for by the whiteboard identification section 173.

In a case of determination in step S94 that the position of the standard diffuse reflection plate (whiteboard) has been searched for by the whiteboard identification section 173, the process proceeds to step S96.

In step S96, the light source spectrum calculation section 142 acquires information associated with the position of the standard diffuse reflection plate (whiteboard) having been searched for by the whiteboard identification section 173, calculates light source spectrums on the basis of the spectral radiance with reference to the set spectral reflectance of the standard diffuse reflection plate, and outputs the calculated light source spectrums as an acquisition result.

Meanwhile, in a case of determination in step S94 that the position of the standard diffuse reflection plate (whiteboard) has not been searched for by the whiteboard identification section 173, the process proceeds to step S95.

In step S95, the light source spectrum calculation section 142 determines whether or not the position of the standard diffuse reflection plate has been designated as the search result and supplied via the input section 185 by operation of the touch panel 111 by the user.

In a case of determination in step S95 that the position of the standard diffuse reflection plate has been designated as the search result and supplied via the input section 185 by operation of the touch panel 111 by the user, the process proceeds to step S96.

Specifically, in this case, the light source spectrum calculation section 142 acquires information associated with the position of the standard diffuse reflection plate (whiteboard) input by operation of the touch panel 111 by the user, as information associated with the position of the standard diffuse reflection plate (whiteboard) having been searched for by the whiteboard identification section 173, calculates light source spectrums on the basis of the spectral radiance with reference to the set spectral reflectance of the standard diffuse reflection plate, and outputs the calculated light source spectrums as an acquisition result.

In a case of determination in step S95 that the position of the standard diffuse reflection plate has not been designated as the search result and not supplied via the input section 185 by operation of the touch panel 111 by the user, the process proceeds to step S97.

In step S97, the light source spectrum calculation section 142 outputs information indicating that the light source spectrums cannot be acquired.

The process for acquiring the light source spectrums is achieved by the foregoing process. In a case where the light source spectrums are acquirable, a calculation result is adopted. In a case where the light source spectrums are not acquirable, information indicating failure of acquisition is output.

### <Functional Measuring Process>

Described next with reference to a flowchart in FIG. 29 will be a functional measuring process performed by the functional measuring section 145.

In step S111, the plant filter 211 acquires NDVIs and PRIS calculated by the vegetation index calculation section 144, extracts, by filtering, the PRIs corresponding to the NDVIs having values within a predetermined range, and outputs the extracted PRIs to the leaf surface light intensity filter 212.

In step S112, the leaf surface light intensity estimation section 213 estimates leaf surface light intensity on the basis of spectral radiance, and outputs an estimation result to the leaf surface light intensity filters 212 and 216.

In step S113, the leaf surface light intensity filter 212 extracts the PRIs corresponding to predetermined leaf surface light intensity by filtering, from the PRIs extracted and supplied from the plant filter 211, and outputs the extracted PRIs corresponding to predetermined leaf surface light intensity as environmental stress responses (Filtered PRIs).

In step S114, the chlorophyll fluorescence calculation section 214 calculates chlorophyll fluorescence (SIF) on the basis of spectral radiance, and outputs the calculated chlorophyll fluorescence to the plant filter 215.

In step S115, the plant filter 215 acquires the NDVIs calculated by the vegetation index calculation section 144 and the chlorophyll fluorescence (SIF) supplied from the chlorophyll fluorescence calculation section 214, extracts, by filtering, the chlorophyll fluorescence (SIF) corresponding to the NDVIs having values within a predetermined range, and outputs the extracted chlorophyll fluorescence (SIF) to the leaf surface light intensity filter 216.

In step S116, the leaf surface light intensity filter 216 extracts, by filtering, the chlorophyll fluorescence (SIF) indicating predetermined leaf surface light intensity in the chlorophyll fluorescence (SIF) supplied from the plant filter 215 and corresponding to the NDVIs having values within the predetermined range, and outputs the extracted chlorophyll fluorescence (SIF) as information associated with photosynthesis (Filtered SIF).

The information associated with photosynthesis (Filtered SIF) and the environmental stress responses (Filtered PRIs) are generated and output on the basis of the spectral radiance, the PRIs, and the NDVIs by the foregoing process.

### 3. Example Executed by Software

Meanwhile, the series of processes described above may be executed by hardware, or may be executed by software. In a case where the series of processes are executed by software, a program constituting this software is installed from a recording medium into a computer incorporated in dedicated hardware or a computer capable of executing various functions under various programs installed in the computer, such as a general-purpose computer.

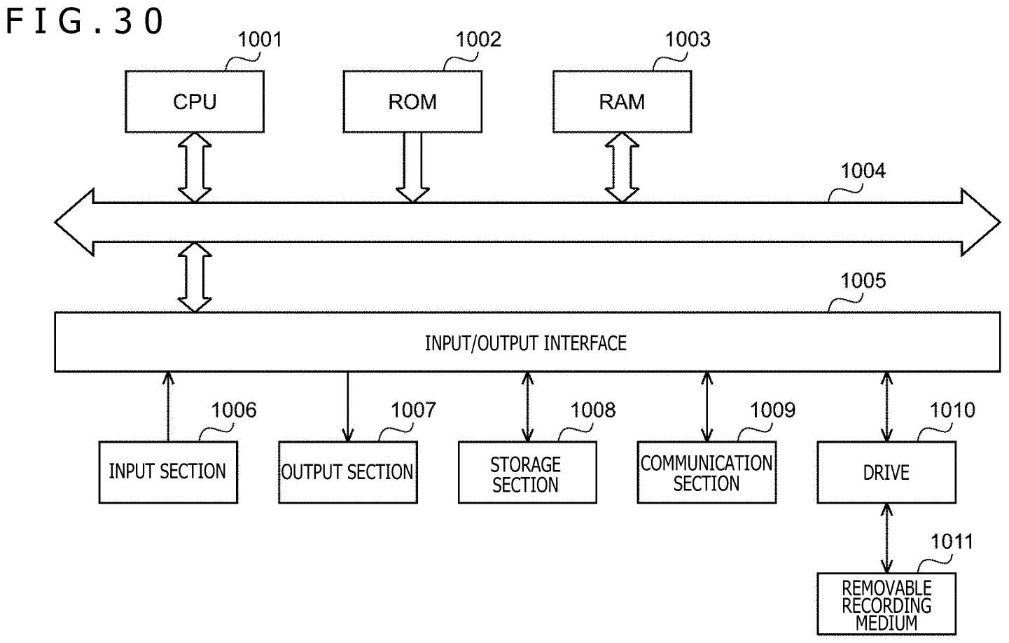

FIG. 30 illustrates a configuration example of a general-purpose computer. This computer has a built-in CPU (Central Processing Unit) 1001. An input/output interface 1005 is connected to the CPU 1001 via a bus 1004. A ROM (Read Only Memory) 1002 and a RAM (Random Access Memory) 1003 are connected to the bus 1004.

Connected to the input/output interface 1005 are an input section 1006 including a keyboard, a mouse, or other input devices through which the user inputs an operation command, an output section 1007 outputting a processing operation screen and an image of a processing result to a display device, a storage section 1008 including a hard disk drive or the like for storing programs and various data, and a communication section 1009 including a LAN (Local Area Network) adopter or the like and executing a communication process via a network typified by the Internet. Further connected to the input/output interface 1005 is a drive 1010 which reads and writes data from and to a removable storage medium 1011 such as a magnetic disk (including a flexible disk), an optical disk (including a CD-ROM (Compact Disc-Read Only Memory) and a DVD (including a Digital Versatile Disc)), a magneto-optical disk (including an MD (Mini Disc), or a semiconductor memory.

The CPU 1001 executes various types of processes according to a program stored in the ROM 1002 or a program read from the removable storage medium 1011 such as a magnetic disk, an optical disk, a magneto-optical disk, or a semiconductor memory, installed into the storage section 1008, and loaded from the storage section 1008 to the RAM 1003. Data and the like necessary for the CPU 1001 to execute various processes are also stored in the RAM 1003 as necessary.

According to the computer configured as above, the CPU 1001 performs the series of processes described above by loading a program stored in the storage section 1008 into the RAM 1003 via the input/output interface 1005 and the bus 1004 and executing the loaded program, for example.

The program executed by the computer (CPU 1001) can be recorded in the removable storage medium 1011 such as a package medium, and provided in this form, for example. Alternatively, the program can be provided via a wired or wireless transfer medium such as a local area network, the Internet, and digital satellite broadcasting.

The program of the computer can be installed into the storage section 1008 via the input/output interface 1005 by attaching the removable storage medium 1011 to the drive 1010. Alternatively, the program can be received by the communication section 1009 via a wired or wireless transfer medium, and installed into the storage section 1008. Instead, the program can be installed in the ROM 1002 or the storage section 1008 beforehand.

Note that the program executed by the computer may be a program under which the processes are performed in time series in the order described in the present description, or a program under which the processes are performed in parallel or at necessary timing such as an occasion when a call is made.

Note that the CPU 1001 in FIG. 30 achieves the functions of the spectral processing unit 102, the spectral application unit 103, the visualization unit 104, the statistical analysis unit 105, the recognition processing unit 106, and the system control unit 107 in FIG. 8.

In addition, a system in the present description refers to a set of a plurality of constituent elements (devices, modules (parts), or the like). A set of constituent elements are regarded as a system regardless of whether or not all of the constituent elements are in an identical housing. Accordingly, a plurality of devices accommodated in different housings and connected to each other via a network and one device which accommodates a plurality of modules in one housing are both regarded as systems.

Note that embodiments according to the present disclosure are not limited to the embodiment described above, and can be modified in various manners without departing from the subject matters of the present disclosure.

For example, the present disclosure can have a configuration of cloud computing where one function is shared by a plurality of devices and performed by the devices in cooperation with each other via a network.

Moreover, the steps described with reference to the above flowcharts can each be executed by one device, or can be shared and executed by a plurality of devices.

Further, in a case where one step includes a plurality of processes, the plurality of steps included in the one step can be executed by one device, or can be shared and executed by a plurality of devices.

Note that the present disclosure can also be configured as follows.

<1>

An imaging device including:
a spectral unit that separates incident light coming from a measurement target;
a spectral front end that generates spectral Raw data on the basis of a spectral result obtained by the spectral unit;
a spectral reflectance calculation section that calculates spectral reflectance of the measurement target on the basis of the spectral Raw data;
a visualized image forming section that forms a visualized image on the basis of a specific value of the spectral reflectance; and
a display section that displays the visualized image in real time.
   <2>

The imaging device according to <1>, further including:
a state information calculation section that calculates state information indicating a state of the measurement target, on the basis of the specific value of the spectral reflectance,
in which the visualized image forming section forms the visualized image on the basis of the state information.
   <3>

The imaging device according to <2>, further including:
a spectral radiance calculation section that calculates spectral radiance from the spectral Raw data,
in which the state information calculation section calculates the state information indicating the state of the measurement target, on the basis of the spectral radiance and the spectral reflectance.
   <4>

The imaging device according to <3>,
in which the spectral reflectance calculation section calculates the spectral reflectance of the measurement target on the basis of the spectral radiance.
   <5>

The imaging device according to any one of <1> to <4>,
in which the spectral unit separates the incident light into at least four types or more of wavelength bands including visible light and near infrared light.
   <6>

The imaging device according to any one of <1> to <5>,
in which the spectral unit is of a spectral type using diffraction gratings (CTIS: Computed Tomography Imaging Spectrometer), a surface plasmon resonance type, a Fourier spectral type, a Fabry-Perot type, and a multi-lens band-pass filter type.
   <7>

The imaging device according to <2>,
in which the state information includes at least any one of a vegetation index of a plant corresponding to the measurement target and a trait and an environmental response of the plant.
   <8>

The imaging device according to <7>,
in which the vegetation index includes at least any one of an NDVI (Normalized Difference Vegetation Index) and a PRI (Photochemical Reflectance Index) of the plant corresponding to the measurement target.
   <9>

The imaging device according to <7>,
in which the trait and the environmental response of the plant includes at least any one of information associated with photosynthesis and an environmental stress response of the plant corresponding to the measurement target.
   <10>

The imaging device according to <2>,
in which the state information is information indicating a deterioration state of concrete corresponding to the measurement target.
   <11>

The imaging device according to <3>,
in which the state information calculation section generates the state information including two-dimensional data, and
the visualized image forming section forms a color map image as the visualized image by applying color mapping according to a value of the state information including the two-dimensional data.
   <12>

The imaging device according to <11>, further including:
an RGB image forming section that forms an RGB image on the basis of the spectral reflectance; and
an image synthesizing section that synthesizes the RGB image and the color map image to form a synthetic image,
in which the display section displays the synthetic image as the visualized image.
   <13>

The imaging device according to <12>,
in which the image synthesizing section superimposes the color map image of a region exhibiting a larger value than a predetermined value or a region exhibiting a lower value than the predetermined value on the RGB image, on the basis of the state information including the two-dimensional data, and synthesizes the color map image and the RGB image to form the synthetic image.
   <14>

The imaging device according to <12>,
in which the image synthesizing section synthesizes the RGB image of a region exhibiting a larger value than a predetermined value or a region exhibiting a lower value than the predetermined value with a masking image that masks regions other than the region, on the basis of the state information including the two-dimensional data, to form the synthetic image.
   <15>

The imaging device according to <12>,
in which the image synthesizing section forms the synthetic image that highlights, on the RGB image, a region exhibiting a larger value than a predetermined value or a region exhibiting a lower value than the predetermined value, on the basis of the state information including the two-dimensional data.
   <16>

The imaging device according to <15>, further including:
a state identification section that identifies a state of a plant corresponding to the measurement target on the basis of the state information including the two-dimensional data,
in which the image synthesizing section forms the synthetic image that highlights, on the RGB image, the region exhibiting the larger value than the predetermined value or the region exhibiting the lower value than the predetermined value, on the basis of a state identification result obtained by the state identification section.
   <17>

The imaging device according to <16>,
in which the state identification section identifies a state of the plant corresponding to the measurement target in a specific identification region by performing an image recognition process based on the RGB image or the color map image included in the state information including the two-dimensional data.
   <18>

The imaging device according to <12>, further including:
an individual identification section that identifies an individual of a plant which corresponds to the measurement target and which is included in the RGB image, the color map image, and the state information including the two-dimensional data.
   <19>

The imaging device according to <18>,
in which the individual identification section identifies the individual of the plant corresponding to the measurement target by giving an identifier to each of the individuals of the plants on the basis of any one of an image recognition process using the RGB image, a two-dimensional barcode within the RGB image, GIS (Geographic Information System) information, and manual input.
   <20>

The imaging device according to <19>,
in which the RGB image, the color map image, and the state information including the two-dimensional data are classified into folders that are different for each of the identifiers and that include, as image-attached data, the identifier for identifying the individual of the plant corresponding to the measurement target included in the RGB image, the color map image, and the state information, and are recorded in a recording device or transferred to destinations different for each of the identifiers.
   <21>

The imaging device according to <12>, further including:
a statistical analysis section that statistically analyzes the state information including the two-dimensional data,
in which the image synthesizing section forms the synthetic image including an analysis value as a statistical analysis result obtained by the statistical analysis section.
   <22>

The imaging device according to <21>, further including:
a graph generation section that generates a graph on the basis of the statistical analysis result and outputs the graph as a graph image,
in which the image synthesizing section forms the synthetic image including the graph image.
   <23>

The imaging device according to <21>, further including:
an input section that receives input of an ROI (Region of Interest) region on the RGB image, the color map image, and the synthetic image,
in which the statistical analysis section statistically analyzes the state information including the two-dimensional data in the ROI region input onto the RGB image, the color map image, and the synthetic image.
   <24>

An operation method of an imaging device, the operation method including steps of:
separating incident light coming from a measurement target;
generating spectral Raw data on the basis of a spectral result of the incident light;
calculating spectral reflectance of the measurement target on the basis of the spectral Raw data;
forming a visualized image on the basis of a specific value of the spectral reflectance; and
displaying the visualized image in real time.
   <25>

A program causing a computer to operate as:
a spectral unit that separates incident light coming from a measurement target;
a spectral front end that generates spectral Raw data on the basis of a spectral result obtained by the spectral unit;
a spectral reflectance calculation section that calculates spectral reflectance of the measurement target on the basis of the spectral Raw data;
a visualized image forming section that forms a visualized image on the basis of a specific value of the spectral reflectance; and
a display section that displays the visualized image in real time.

### REFERENCE SIGNS LIST

31: Imaging device
41: Lens unit
42: LCD
43: Key
101: Optical block
102: Spectral processing unit
103: Spectral application unit
104: Visualization unit
105: Statistical analysis unit
106: Recognition processing unit
107: System control unit
108: Camera control unit
111: Touch panel
112: Recording device
113: Communication device
121: Lens
122: Spectral unit
123: Shutter
124: Image sensor
131: Spectral front end
132: Spectral radiance calculation section
141: Spectral reflectance calculation section
142: Light source spectrum calculation section
143: RGB development section
144: Vegetation index calculation section
145: Functional measuring section
151: Color map
161: Statistical analysis section
162: Graph generation section
171: Individual identification section
172: State identification section
173: Whiteboard identification section
181: Image output section
182: Image synthesizing section
183: Recording section (Codec, compression, file management)
184: External sensor input section
185: Input section
191: Camera control front end
192: AE control section
193: Driver
194: AF control section
195: Driver
211: Plant filter
212: Leaf surface light intensity filter
213: Leaf surface light intensity estimation section
214: Chlorophyll fluorescence calculation section
215: Plant filter
216: Leaf surface light intensity filter

1. An imaging device comprising:
a spectral unit that separates incident light coming from a measurement target;
a spectral front end that generates spectral Raw data on a basis of a spectral result obtained by the spectral unit;
a spectral reflectance calculation section that calculates spectral reflectance of the measurement target on a basis of the spectral Raw data;
a visualized image forming section that forms a visualized image on a basis of a specific value of the spectral reflectance; and
a display section that displays the visualized image in real time.

2. The imaging device according to claim 1, further comprising:
a state information calculation section that calculates state information indicating a state of the measurement target, on the basis of the specific value of the spectral reflectance,
wherein the visualized image forming section forms the visualized image on a basis of the state information.

3. The imaging device according to claim 2, further comprising:
a spectral radiance calculation section that calculates spectral radiance from the spectral Raw data,
wherein the state information calculation section calculates the state information indicating the state of the measurement target, on a basis of the spectral radiance and the spectral reflectance.

4. The imaging device according to claim 3,
wherein the spectral reflectance calculation section calculates the spectral reflectance of the measurement target on the basis of the spectral radiance.

5. The imaging device according to claim 1,
wherein the spectral unit separates the incident light into at least four types or more of wavelength bands including visible light and near infrared light.

6. The imaging device according to claim 1,
wherein the spectral unit is of a spectral type using diffraction gratings (CTIS: Computed Tomography Imaging Spectrometer), a surface plasmon resonance type, a Fourier spectral type, a Fabry-Perot type, and a multi-lens band-pass filter type.

7. The imaging device according to claim 2,
wherein the state information includes at least any one of a vegetation index of a plant corresponding to the measurement target and a trait and an environmental response of the plant.

8. The imaging device according to claim 7,
wherein the vegetation index includes at least any one of an NDVI (Normalized Difference Vegetation Index) and a PRI (Photochemical Reflectance Index) of the plant corresponding to the measurement target.

9. The imaging device according to claim 7,
wherein the trait and the environmental response of the plant includes at least any one of information associated with photosynthesis and an environmental stress response of the plant corresponding to the measurement target.

10. The imaging device according to claim 2,
wherein the state information is information indicating a deterioration state of concrete corresponding to the measurement target.

11. The imaging device according to claim 3,
wherein the state information calculation section generates the state information including two-dimensional data, and
the visualized image forming section forms a color map image as the visualized image by applying color mapping according to a value of the state information including the two-dimensional data.

12. The imaging device according to claim 11, further comprising:
an RGB image forming section that forms an RGB image on the basis of the spectral reflectance; and
an image synthesizing section that synthesizes the RGB image and the color map image to form a synthetic image,
wherein the display section displays the synthetic image as the visualized image.

13. The imaging device according to claim 12,
wherein the image synthesizing section superimposes the color map image of a region exhibiting a larger value than a predetermined value or a region exhibiting a lower value than the predetermined value on the RGB image, on a basis of the state information including the two-dimensional data, and synthesizes the color map image and the RGB image to form the synthetic image.

14. The imaging device according to claim 12,
wherein the image synthesizing section synthesizes the RGB image of a region exhibiting a larger value than a predetermined value or a region exhibiting a lower value than the predetermined value with a masking image that masks regions other than the region, on a basis of the state information including the two-dimensional data, to form the synthetic image.

15. The imaging device according to claim 12,
wherein the image synthesizing section forms the synthetic image that highlights, on the RGB image, a region exhibiting a larger value than a predetermined value or a region exhibiting a lower value than the predetermined value, on a basis of the state information including the two-dimensional data.

16. The imaging device according to claim 15, further comprising:
a state identification section that identifies a state of a plant corresponding to the measurement target on the basis of the state information including the two-dimensional data,
wherein the image synthesizing section forms the synthetic image that highlights, on the RGB image, the region exhibiting the larger value than the predetermined value or the region exhibiting the lower value than the predetermined value, on a basis of a state identification result obtained by the state identification section.

17. The imaging device according to claim 16,
wherein the state identification section identifies a state of the plant corresponding to the measurement target in a specific identification region by performing an image recognition process based on the RGB image or the color map image included in the state information including the two-dimensional data.

18. The imaging device according to claim 12, further comprising:
an individual identification section that identifies an individual of a plant which corresponds to the measurement target and which is included in the RGB image, the color map image, and the state information including the two-dimensional data.

19. The imaging device according to claim 18,
wherein the individual identification section identifies the individual of the plant corresponding to the measurement target by giving an identifier to each of the individuals of the plants on a basis of any one of an image recognition process using the RGB image, a two-dimensional barcode within the RGB image, GIS (Geographic Information System) information, and manual input.

20. The imaging device according to claim 19,
wherein the RGB image, the color map image, and the state information including the two-dimensional data are classified into folders that are different for each of the identifiers and that include, as image-attached data, the identifier for identifying the individual of the plant corresponding to the measurement target included in the RGB image, the color map image, and the state information, and are recorded in a recording device or transferred to destinations different for each of the identifiers.

21. The imaging device according to claim 12, further comprising:
a statistical analysis section that statistically analyzes the state information including the two-dimensional data,
wherein the image synthesizing section forms the synthetic image including an analysis value as a statistical analysis result obtained by the statistical analysis section.

22. The imaging device according to claim 21, further comprising:
a graph generation section that generates a graph on a basis of the statistical analysis result and outputs the graph as a graph image,
wherein the image synthesizing section forms the synthetic image including the graph image.

23. The imaging device according to claim 21, further comprising:
an input section that receives input of an ROI (Region of Interest) region on the RGB image, the color map image, and the synthetic image,
wherein the statistical analysis section statistically analyzes the state information including the two-dimensional data in the ROI region input onto the RGB image, the color map image, and the synthetic image.

24. An operation method of an imaging device, the operation method comprising steps of:
separating incident light coming from a measurement target;
generating spectral Raw data on a basis of a spectral result of the incident light;
calculating spectral reflectance of the measurement target on a basis of the spectral Raw data;
forming a visualized image on a basis of a specific value of the spectral reflectance; and
displaying the visualized image in real time.

25. A program causing a computer to operate as:
a spectral unit that separates incident light coming from a measurement target;
a spectral front end that generates spectral Raw data on a basis of a spectral result obtained by the spectral unit;
a spectral reflectance calculation section that calculates spectral reflectance of the measurement target on a basis of the spectral Raw data;
a visualized image forming section that forms a visualized image on the basis of a specific value of the spectral reflectance; and
a display section that displays the visualized image in real time.
